(19) United States
(12) Patent Application Publication
(10) Pub. No.: US 2025/0183574 A1
(43) Pub. Date: Jun. 5, 2025

(54) SPLICE BLOCK SYSTEM FOR CONNECTING MULTIPLE COMPONENTS IN A POWER DISTRIBUTION SYSTEM

(71) Applicant: EATON INTELLIGENT POWER LIMITED, Dublin 4 (IE)

(72) Inventors: Jason Degen, Plymouth, MI (US); James Dawson, West Chicago, IL (US)

(21) Appl. No.: 18/837,116

(22) PCT Filed: Feb. 9, 2023
(86) PCT No.: PCT/EP2023/025059

§ 371 Date: Aug. 8, 2024

Related U.S. Application Data
(60) Provisional application No. 63/308,488, filed on Feb. 9, 2022.

(51) Int. Cl. H01R 13/187; H01R 13/11; H01R 13/512; H01R 13/52

(52) U.S. Cl. CPC H01R 13/187; H01R 13/114; H01R 13/512; H01R 13/5213; H01R 2201/26

(57) ABSTRACT

The splice block system is configured to connect multiple components in a power distribution system. The splice block including: (i) an external housing having a removable cover. (ii) a mating assembly coupled to the removable cover and including a first female terminal assembly, a second female terminal assembly, and a third female terminal assembly. (iii) a first male connector assembly having a first male terminal assembly. (iv) a second male connector assembly having a second male terminal assembly, and (v) a third male connector assembly having a third male terminal assembly. Wherein a positioning force F_{P} is applied to each of the first, second, and third male terminal assemblies and a coupling force F_{C}, that is oriented substantially perpendicular to said positioning force Fp, is applied to the removable cover in order to cause an extent of the first, second, and third male terminal assemblies to be positioned within the respective first, second, and third female terminal assemblies.

### RELATED APPLICATIONS

This application claims the benefit from U.S. provisional patent application No. 63/308,488, which is hereby incorporated by reference in its entirety for all purposes.

### FIELD OF DISCLOSURE

The present disclosure relates to a splice block system for use in electrically connecting multiple components in a power distribution system, like those found in a motor vehicle. More specifically, the splice block system includes a plurality of electrical connector assemblies to electrically couple one device or component to at least two other devices or components in a power distribution system or environment.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for a variety of reasons, including but not limited to, monitoring, improving and/or controlling vehicle performance, emissions, safety and creates comforts to the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies due to a number of conditions, including but not limited to, space constraints that make initial installation difficult, harsh operating conditions, large ambient temperature ranges, prolonged vibration, heat loads, and longevity, all of which can lead to component and/or connector failure. For example, incorrectly installed connectors, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all of the automotive manufacturers and their direct suppliers is estimated to be between $50 billion and $150 billion, worldwide. In light of these challenging electrical environments, considerable time, money, and energy have been expended to find power distribution components that meet the needs of the markets. This disclosure addresses the shortcomings of conventional power distribution components. A full discussion of the features and advantages of the present disclosure is deferred to the following detailed description, which proceeds with reference to the accompanying drawings.

### SUMMARY OF THE INVENTION

The present disclosure relates to an electrical connector system having an external housing having a removable cover. A first male connector assembly, a second male connector assembly, a third male connector assembly, are positioned within the external housing using a positioning force F_{P}. The first, second, and third male connector assemblies respectively having first, second, and third male terminal assembly. Said first, second, and third male terminal assembly include: (i) a male terminal body with a front wall and spring receiver, and (ii) an internal spring member. The mating assembly is also positioned within the external housing, coupled to the removable cover and including: (i) a first female terminal assembly, (ii) a second female terminal assembly, and (iii) a third female terminal assembly. Wherein an application of a coupling force F_{C} is applied to the cover, which causes an extent of the first, second, and third male terminal assemblies to be positioned within the first, second, and third female terminal assemblies of the mating assembly, and wherein said positioning force F_{P} is oriented substantially perpendicular to the coupling force F_{C}.

The electrical connector system may also have an external housing having: (i) an arrangement of side walls, and (ii) a bottom wall coupled to the arrangement of the side walls. A first male connector assembly and a second male connector assembly are positioned within the external housing and respectively include a first male terminal assembly with a front wall and a second male terminal assembly with a front wall. Wherein the first and second male terminal assemblies are positioned within the external housing, and the front walls of the first and second male terminal assemblies are: (i) substantially co-planar, and (ii) positioned substantially parallel with an extent of the bottom wall.

The electrical connector system may also have an external housing having a conductive cover, and a mating assembly coupled to the cover. Said mating assembly including: (i) a first female terminal assembly, (ii) a second female terminal assembly, (iii) a third female terminal assembly, (iv) a bridge coupled to the first, second, and third female terminal assemblies and configured to electrically couple the first, second, and third female terminal assemblies to one another; and (v) a non-conductive bridge housing positioned between the bridge and the cover.

Other aspects and advantages of the present disclosure will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of the splice block system with multiple electrical connector assemblies, the splice block system shown in a connected state S_{CON};

FIG. 2 is a perspective view of the splice block system of FIG. 1 in a disconnected state S_{DCON}, wherein an upper extent of the external housing has been disconnected from the external housing to expose a mating assembly and a plurality of male connector assemblies;

FIG. 3 is a perspective view of one of the male connector assemblies having a male terminal assembly and a strain relief assembly;

FIG. 4 is a perspective view of the male terminal assembly of FIG. 3 in a decoupled state S_{DC};

FIG. 5 is a perspective view of the male terminal assembly of FIG. 3 in a partially coupled state S_{PC};

FIG. 6 is a left side view of the male terminal assembly of FIG. 3 in a fully coupled state S_{FC};

FIG. 7 is a cross-sectional view of the male terminal assembly taken along line 7-7 of FIG. 6;

FIG. 8 is a bottom perspective view of the upper extent of the external housing and the mating assembly;

FIG. 9 is a front view of the mating assembly with an internal female housing assembly, a plurality of female terminal assemblies, and a bridge;

FIG. 10 is a perspective view of the mating assembly of FIG. 9;

FIG. 11 is a front view of the plurality of female terminal assemblies connected to the bridge;

FIG. 12 is a perspective view of the female terminal assemblies connected to the bridge;

FIG. 13 is a side view of the female terminal assemblies connected to the bridge;

FIG. 14 is a perspective view of the splice block system in a disassembled state S_{DA};

FIG. 15 is a perspective view of the splice block system in a partially assembled state S_{PA};

FIG. 16 is a top view of the splice block system in a fully assembled state S_{FA};

FIG. 17 is a perspective view of the splice block system of FIG. 16;

FIG. 18 is a perspective view of the splice block system in a disconnected state S_{DCON};

FIG. 19 is a side view of the splice block system in the connected state S_{CON};

FIG. 20 is a cross-sectional view of the splice block system taken along line 20-20 of FIG. 19;

FIG. 21 is a side view of the splice block system in the connected state S_{CON};

FIG. 22 is a cross-sectional view of the splice block system taken along line 22-22 of FIG. 21;

FIG. 23 is a side view of the splice block system in the connected state S_{CON};

FIG. 24 is a cross-sectional view of the splice block system taken along line 24-24 of FIG. 23;

FIG. 25 is a side view of the splice block system in the connected state S_{CON};

FIG. 26 is a cross-sectional view of the splice block system taken along line 26-26 of FIG. 25;

FIG. 27 is a side view of the splice block system in the connected state S_{CON};

FIG. 28 is a cross-sectional view of the splice block system taken along line 28-28 of FIG. 27;

FIG. 29 is a partial cross-sectional view of the splice block system in the connected state S_{CON};

FIG. 30 is a side view of the male terminal assembly and an extent of the mating assembly in the connected state S_{CON}:

FIG. 31 is a cross-sectional view of the male terminal assembly and the female terminal assembly taken along line 31-31 of FIG. 30;

FIG. 32 is a perspective view of a vehicle skateboard S installed in a vehicle V that includes the splice block system;

FIG. 33 is a perspective view of a motor vehicle V that includes the splice block system;

FIG. 34 is a perspective view of a bus that includes the splice block system;

FIG. 35 is a perspective view of a ship that includes the splice block system; and

FIG. 36 is a perspective view of a boat that includes the splice block system.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistently with the disclosed methods and systems. Accordingly, the drawings and detailed descriptions are to be regarded as illustrative in nature, not restrictive or limiting.

### I. Introduction

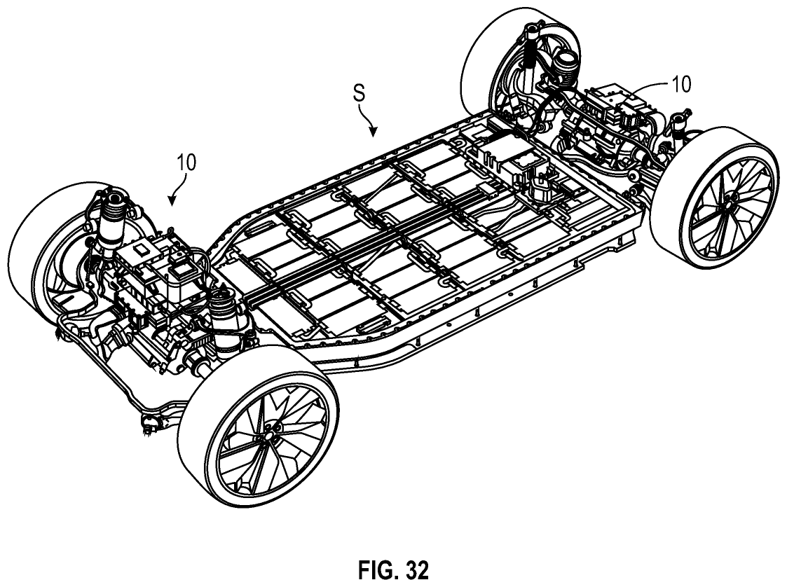

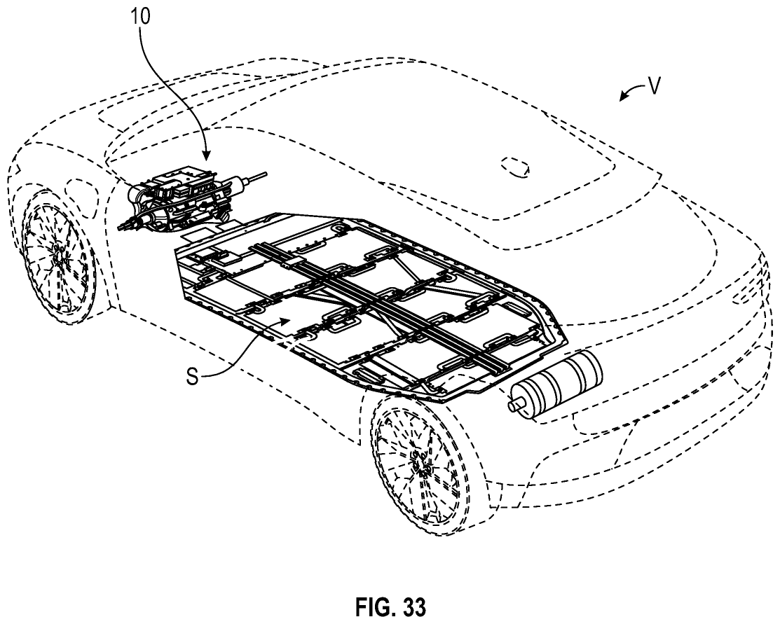

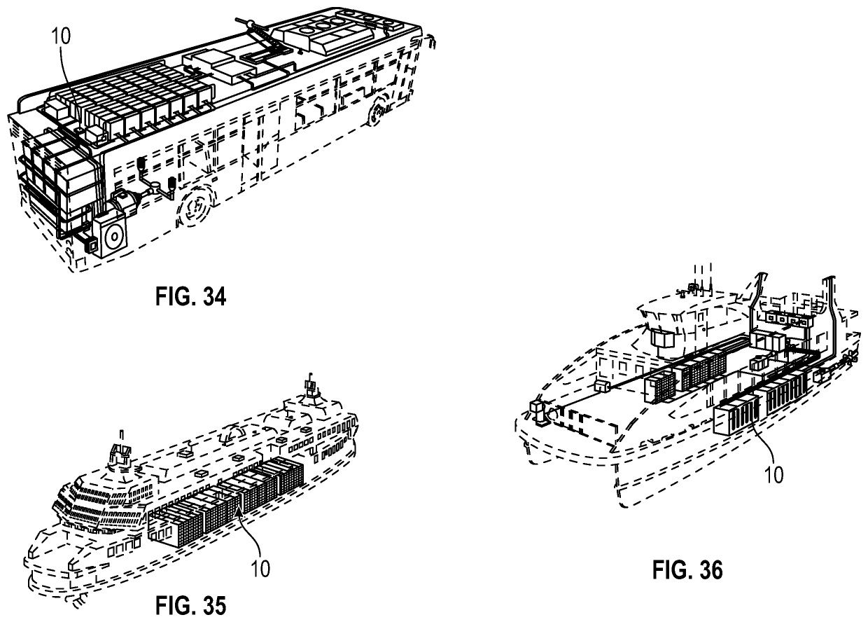

The Figures show a splice block system 10 designed to mechanically and electrically couple one device or component to at least two other devices or components within a power distribution system or environment. For example, a first device or component may be a current supplying component (e.g., power source, such as an alternator or battery) and the second and third devices or components may be two current drawing components (e.g., radiator fan, heated seat, power distribution component, or another current drawing component). Said power distribution system or environment that includes the splice block system 10 may be installed within an airplane, motor vehicle (see FIGS. 32-33), a military vehicle (e.g., tank, personnel carrier, heavy-duty truck, and troop transporter), a bus (see FIG. 34), a locomotive, a tractor, a boat (see FIG. 36), a ship (see FIG. 35), a submarine, a battery pack, a 24-48 volt system, a high-power application, a high-current application, a high-voltage application. The power distribution components are necessary to meet industry standards, production specifications, and performance requirements of the power distribution system and the motor vehicle. It should be understood that multiple splice block systems 10 could be used in a single application, such as multiple splice block systems 10 in the power distribution system of the motor vehicle.

Various aspects of the splice block system 10 are disclosed herein and shown in the Figures. Specifically, the splice block system 10 is comprised of: (i) an external housing 100, (ii) multiple male connector assemblies 1000, 2000, 3000, and (iii) a mating assembly 4000. As described below, the male connector assemblies 1000, 2000, 3000 are primarily composed of: (i) male terminal assemblies 1430, and (ii) a strain relief assembly 1800, 2800, 3800. The mating assembly 4000 is primarily composed of: (i) an internal female housing assembly 4010, (ii) a plurality of female terminal assemblies 4430, 4530, 4630, and (iii) an internal current distribution component, such as bridge or bus 4800. While the figures show three male connector assemblies 1000, 2000, 3000 that are connected via the mating assembly 4000, it should be understood that fewer (i.e., two) male connector assemblies 1000, 2000, 3000 may be included in the splice block system 10 or additional (e.g., twenty) male connector assemblies 1000, 2000, 3000 may be included in the splice block system 10.

It should be understood that: (i) a first portion of the multiple male connector assemblies 1000, 2000, 3000 are configured as “supplying” male connector assemblies 1000, wherein said supplying male connector assemblies 1000 supply current into the system 10 from an external device, and (ii) a second portion of the multiple male connector assemblies 1000, 2000, 3000 are configured as “receiving” male connector assemblies 2000, 3000, wherein said receiving male connector assemblies 2000, 3000 receive current from the system 10 and provide it to an external device. Accordingly, a varied arrangement of supplying and receiving male connector assemblies 1000, 2000, 3000 and the mating assembly 4000 is contemplated by this Application. For example, the system 10 may include one supply male connector assembly and three receiving male connector assemblies. In another example, the system 10 may include four supply male connector assemblies and one receiving male connector assembly. In a further example, the system 10 may include two suppling male connector assemblies and five receiving male connector assemblies. In a final example, the system 10 may include six suppling male connector assemblies and two receiving male connector assemblies. It should also be understood that if the system 10 include more supplying male connector assemblies then receiving male connector assemblies or utilizes higher current carrying supplying male connector assemblies and lower current carrying receiving male connector assemblies, then the power distribution system must be configured to ensure that the supplying male connector assemblies do not overpower the receiving male connector assemblies. In the above examples, the supplying and receiving male connector assemblies may be electrically connected using a number (e.g., one to twenty) of mating assemblies. As such, the above disclosure shall not limit the combinations of supplying male connector assemblies, receiving male connector assemblies and mating assemblies.

### II. External Housing

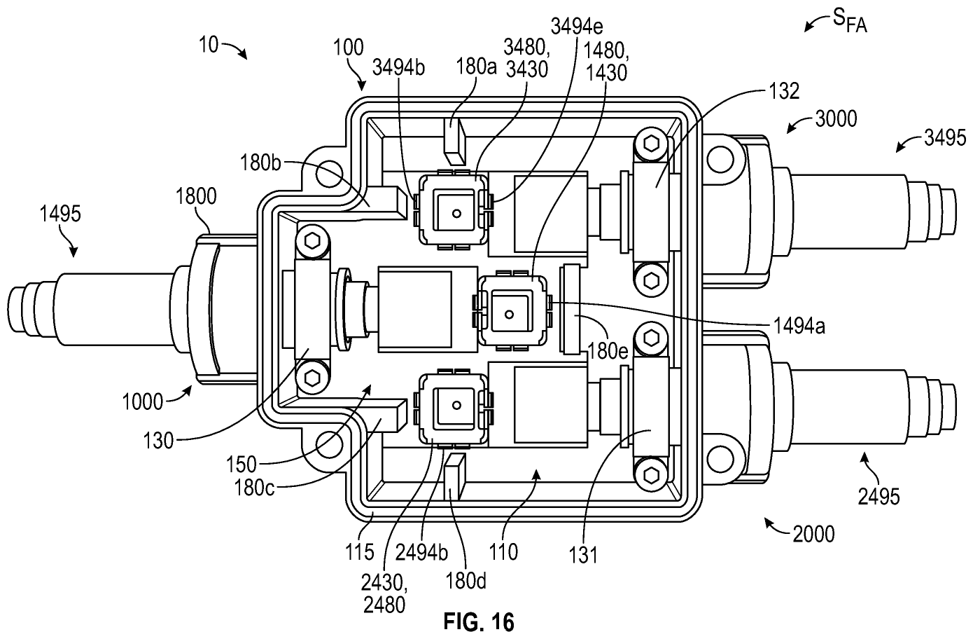

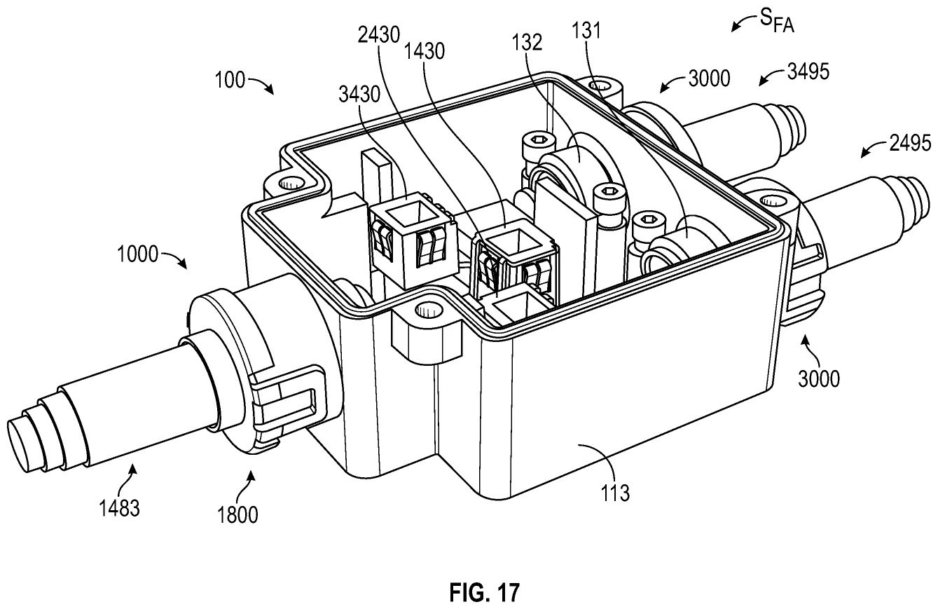

The external housing 100 is primarily composed of: (i) an upper extent 105, such as cover or lid 105a, (ii) a lower extent 110, such as a bottom, and (iii) an arrangement of side walls 115. The external housing 100 protects and isolates the connector assemblies 1000, 2000, 3000 and mating assembly 4000 from external forces and elements. To provide this protection and isolation, the housing 100 is formed from both conductive materials, and non-conductive materials. The arrangement of side walls 115 are integrally formed with the lower extent or bottom 110 and include a plurality of openings 122, 124, 126 that are designed to receive extents of the male connector assemblies 1000, 2000, 3000. Each of the openings 122, 124, 126 are sealed by an extent of the male connector assemblies 1000, 2000, 3000, when said assemblies 1000, 2000, 3000 are installed within the system 10. As such, when the system 10 is in the fully assembled S_{FA} (see FIGS. 16 and 17) meets the IP-67 standards, which means that the system 10: (i) can be temporary immersed in liquid at a depth between 15 cm and 1 m for up to 30 minutes, and (ii) will not allow contact dust to enter the external housing 100 during an eight hour airflow test based on airflow.

The external housing 100 also includes a lower insulator member, such as plate 150 that is positioned between an extent of the bottom wall 110 and the rear walls of the male terminal body 1472, 2472, 3472. The lower insulator plate 150 is made from a non-conductive material and is configured to electrically isolate the male terminal assemblies 1430, 2430, 3430 from the bottom wall 110 and the lower extent of the housing 100. In addition to isolating the terminal assemblies 1430, 2430, 3430, the lower insulator plate 150 provides a locator function to inform the installer/operator/assembler precisely where to position the male terminal assemblies 1430, 2430, 3430 within the housing 100 and on the bottom wall 110. The locator function of the lower insulator plate 150 is provided by: (i) a recess, channel or cavity formed in the plate 150, (ii) indicia on the plate 150, or (iii) utilizing the edges of the plate 150.

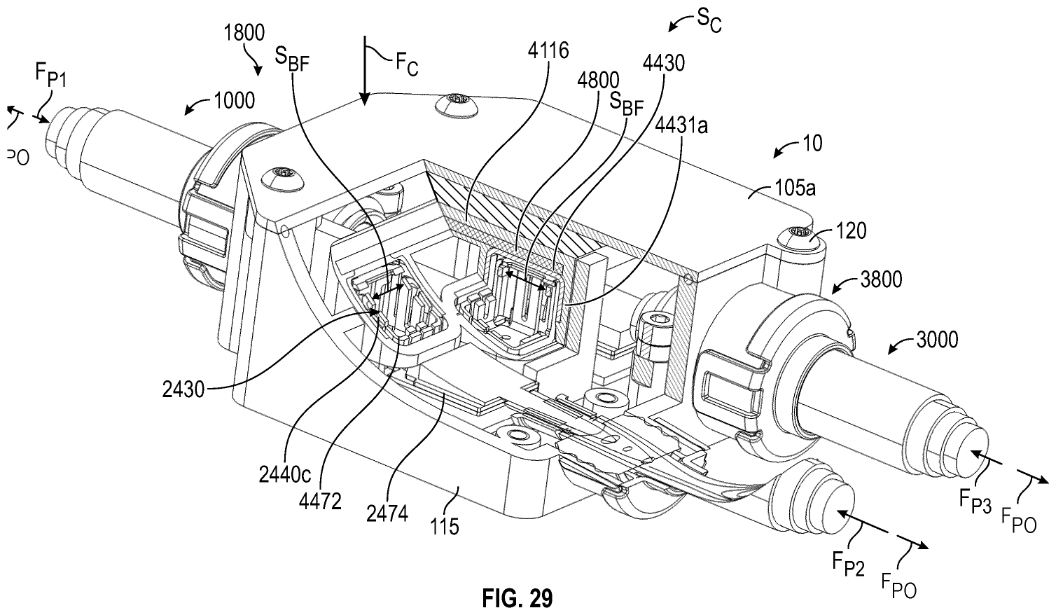

As best shown in FIGS. 16, 28, and 29, the external housing 100 further includes a plurality of internal support walls 180a-180e that are designed to be positioned adjacent to and engage extents of the mating assembly 4000. The positional relationship between an exterior surface of the mating assembly 4000 and the internal support walls 180a-180e help reduce failure modes of the system 10, improve the life of the system 10, and help ensure that the male connector assemblies 1000, 2000, 3000 do not inadvertently move within the housing 100. Referring to FIG. 16, the lower insulator plate 150 includes at least one recess or gap that receives a lower extent of the internal support walls 180a-180e such that these two components structurally interact. As shown in FIG. 16 and a number of cross-sectional views, the internal support walls 180a-180e have an appreciable height, as measured from the bottom housing wall 110. Preferably, the height of the internal support walls 180a-180e is less than a height of the side walls 115 of the housing 100.

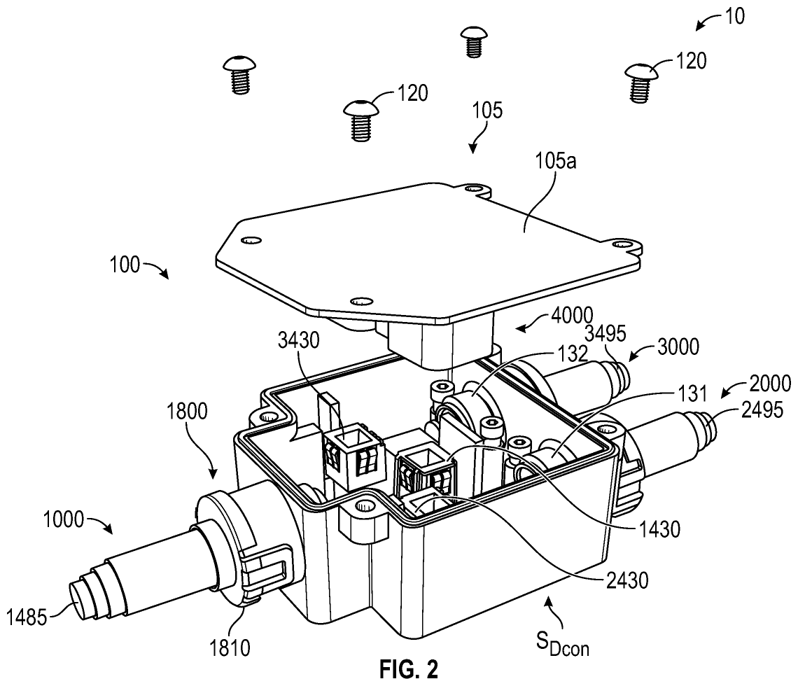

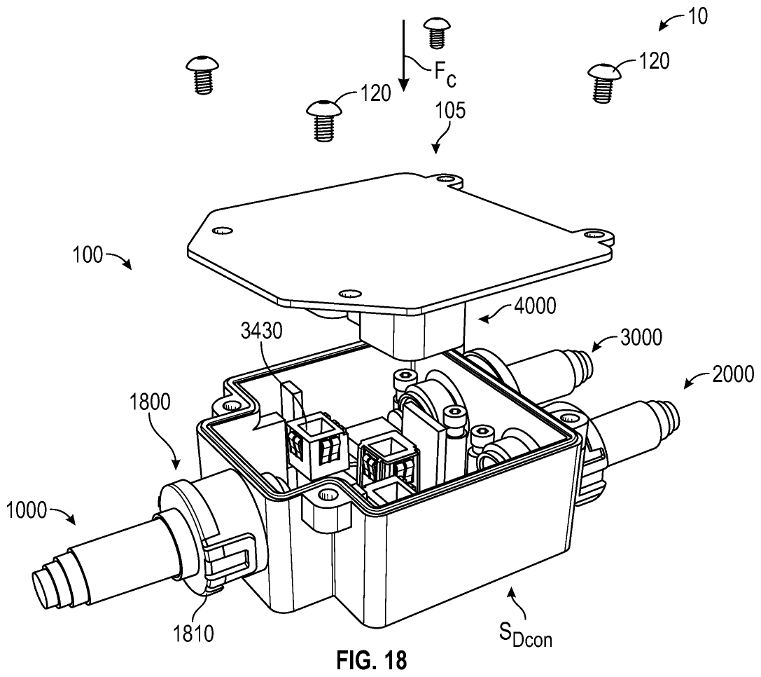

As shown in FIGS. 2, 8, and 18, the cover 105a is removably coupled to the arrangement of side walls 115 via: (i) an application of a substantially vertical (e.g. downward or upward) coupling force F_{C} (see FIG. 18), (ii) insertion of mechanical fasteners 120 within openings formed in the cover 105a and side wall arrangement 115, and (iii) tightening of mechanical fasteners 120 to secure/remove said cover 105a from the arrangement of side walls 115. The ability to secure/remove the cover 105a to/from the external housing 100 is beneficial because it allows the installer a large area to mechanically secure (e.g., with ferrule compression clips 130, 131, 132) the male connector assemblies 1000, 2000, 3000 within the external housing 100. In particular, the wire 1495, 2495, 3495 is directly secured to the bottom wall 110 of the external housing 100, while the male terminal assemblies 1000, 2000, 3000 are indirectly secured within the external housing 100 via the direct securement of the wires 1495, 2495, 3495. This arrangement allows the for securement of the male connector assemblies 1000, 2000, 3000 to the external housing 100 without relying solely on an strain relief assembly 1800, 2800, 3800 or any additional structure that is positioned outside of the side walls 115.

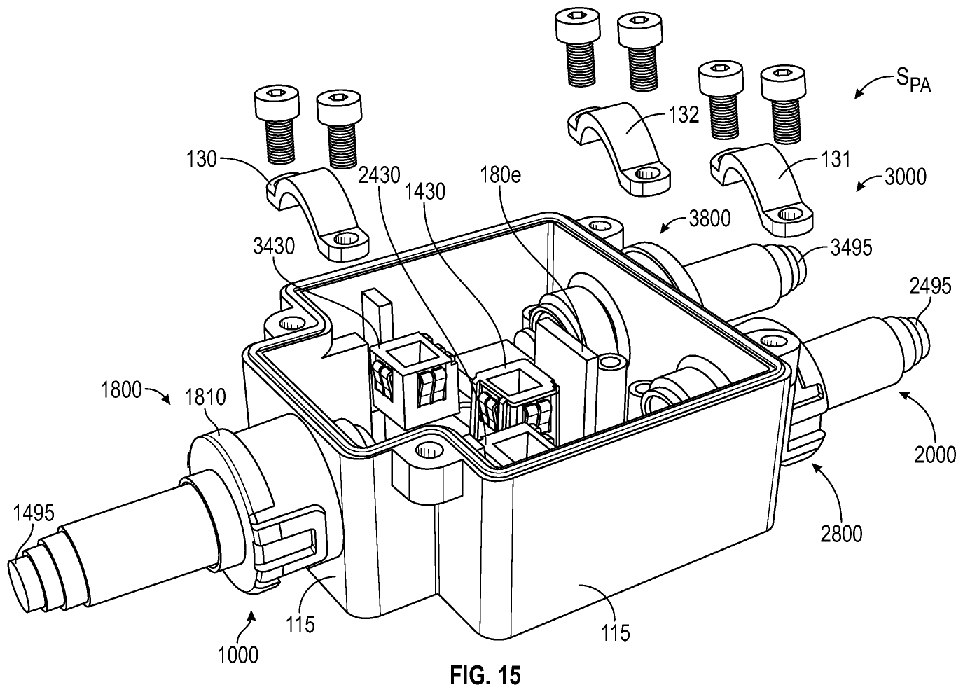

The configuration of the external housing 100 is designed to allow the male terminal assemblies 1430, 2430, 3430 to be inserted into the external housing 100 using substantially lateral or substantially horizontal positioning force F_{P}, where the positioning force F_{P} is oriented parallel to a horizontal support surface that the housing 100 rests upon. The positioning force F_{P} is oriented parallel to a plane in which the cover 105a resides and to a plane in which the bottom housing wall 110 resides. Specifically, the first or supply male terminal assembly 1430 is inserted using a first substantially lateral positioning force F_{P1}, the second or a first receiver male terminal assembly 2430 is inserted using a second substantially lateral positioning force F_{P2}, the third or second receiver male terminal assembly 3430 is inserted using a third substantially lateral positioning force F_{P3}. The first substantially lateral positioning force F_{P1} is positioned in an opposite direction from the second and third substantially lateral positioning forces F_{P2-P3}, however, the first, second, and third substantially lateral positioning forces F_{P1-P3} are co-planar with each other. The substantially lateral positioning forces F_{P1-P3} are oriented substantially perpendicular to the substantially vertical coupling force F_{C}. Due to this perpendicular arrangement, the positioning forces F_{P1-P3} and the coupling force F_{C} are not aligned, co-linear, co-planar, or parallel. The arrangement of the positioning forces F_{P1-P3} and the coupling force F_{C} necessitates an extremely high “pull-out force,” F_{PO} where a low pull-out force is a potential failure mode of the system 10. Specifically, the pull-out force F_{PO} is a force applied on the wires 1495, 2495, 3495 in a direction that is opposite of the positioning forces F_{P1-P3}. The pull-out force failure mode is effectively eliminated because the pull-out force must be so large that it overcomes both (i) the mechanical securement of the male terminal assembly 1000, 2000, 3000 (e.g., the ferrule compression clips 130, 131, 132) and (ii) the connection between the wire 1495, 2495, 3495 and the male terminal assembly 1000, 2000, 3000. In contrast, a lesser pull-out force can lead to failure in a conventional splice block device where the positioning forces and the coupling force are aligned or substantially co-linear, whereupon the male terminal assembly disengages from the female terminal assembly without causing the wire to disconnect from the male terminal assembly. With the inventive system 10, once the male terminal assembly 1000, 2000, 3000 have been inserted and secured within the external housing 100, the system 10 moves from a partially assembled state S_{PA} (shown in FIG. 15) to a fully assembled state S_{FA} (shown in FIGS. 16-17).

Based on the above disclose, it should be understood that the coupling force F_{C} is oriented substantially parallel to: (a) a vertical extent of the side wall arrangement 115, and/or (b) side wall portions 1492b, 1492d. Also, the coupling force F_{C} is oriented substantially perpendicular to: (a) a horizontal extent or surface 105b of the cover 105a, (b) a horizontal extent of the bottom wall 110, and/or (c) an outer surface of the front male terminal walls 1480, 2480, 3480. It should also be understood that the positioning forces F_{P1-P3} are oriented substantially perpendicular to: (a) a vertical extent of the side wall arrangement 115, (b) a first extent of the resultant spring biasing force S_{F}, and/or (c) side wall portions 1492b, 1492d. Also, the positioning forces F_{P1-P3} are oriented substantially parallel to: (a) the horizontal extent or surface 105b of the cover 105a, (b) a horizontal extent or surface 110a of the bottom wall 110, (c) a second extent of the resultant spring biasing force S_{F}, and/or (d) the outer surface of the front male terminal walls 1480, 2480, 3480. It should be understood that in other embodiments, the external housing 100 may be omitted, may have a different shape, the cover 105a may include a portion or an extent of the side wall arrangement 115. Also, the external housing 100 may not meet the IP-67 standard, may only provide little, if any, EMI shielding. Furthermore, the external housing 100 may be made of conductive plastic, may be stamped, injection-molded, 3D printed, or formed out of any similar material in any similar manner.

### III. Supply Male Connector Assembly

The first or supply male connector assembly 1000 which supplies current into the system 10 is primarily composed of: (i) a supply male terminal assembly 1430, (ii) a wire 1495, and (iii) a strain relief assembly 1800.

### A. Supply Male Terminal Assembly

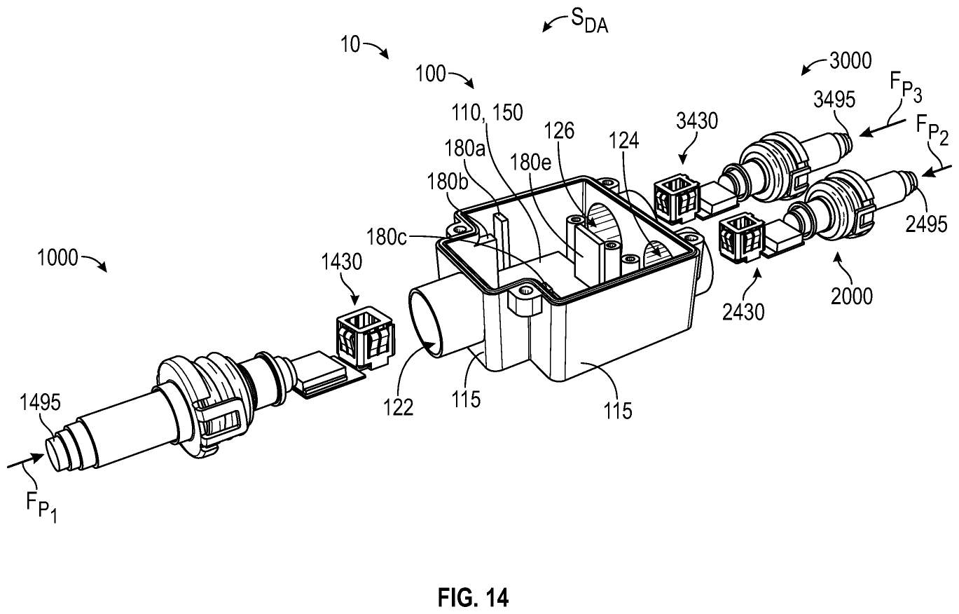

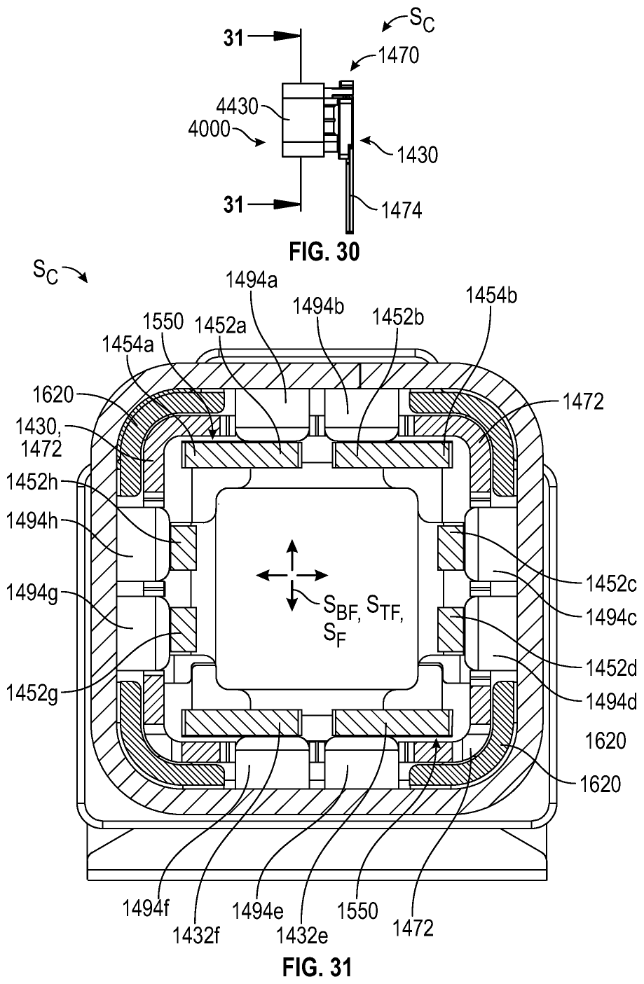

FIGS. 2-7, 14-18, 20, 22, and 28-31 provide various views of the supply male terminal assembly 1430. The male terminal assembly 1430 includes a spring member 1440c and a male terminal 1470. The male terminal 1470 includes a male terminal body 1472 and a male terminal connection member or plate 1474. Said male terminal body 1472 includes: (i) a first or front male terminal wall 1480, (ii) an arrangement of male terminal side walls 1482a-1482d, and (iii) a second or rear male terminal wall 1484. The combination of these walls 1480, 1482a-1482d forms a spring receiver 1486 that is designed to receive the internal spring member, male spring member, or second spring member 1440c.

### 1. Internal Spring Member

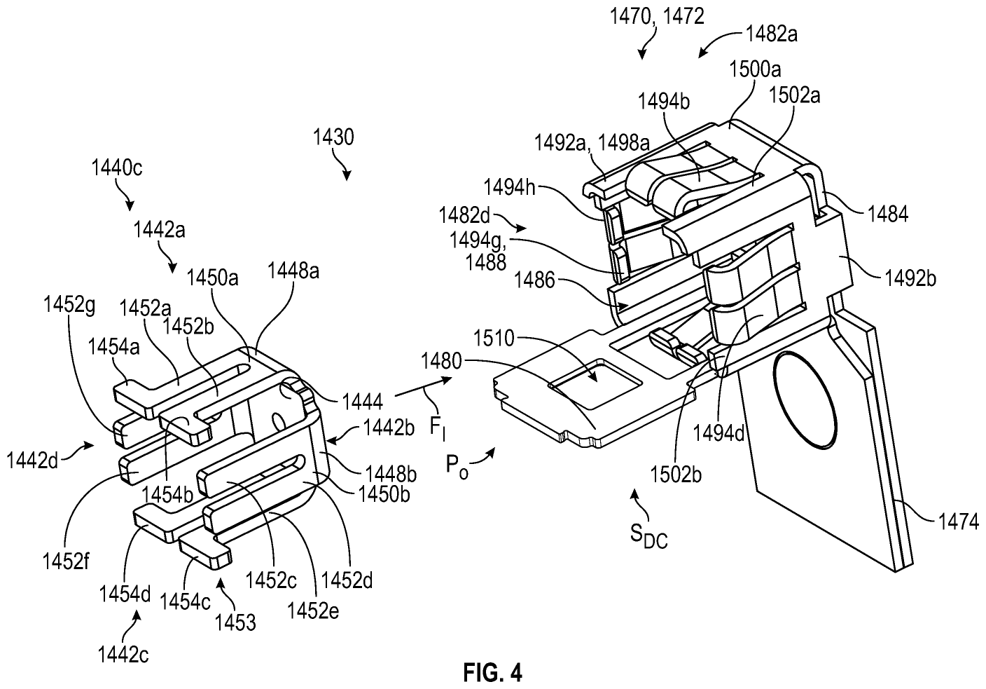

Referring to FIG. 4, the internal spring member 1440c includes an arrangement of spring member side walls 1442a-1442d and a rear spring wall 1444. Each of the spring member side walls 1442a-1442d is comprised of: (i) a first or arched spring section 1448a-1448d, (ii) a second spring section, a base spring section, or a middle spring section 1450a-1450d, (iii) a third section or spring arm 1452a-1452h, and (iv) a forth section or centering means 1453. The arched spring sections 1448a-1448d extend between the rear spring wall 1444 and the base spring sections 1450a-1450d and position the base spring sections 1450a-1450d substantially perpendicular to the rear spring wall 1444. In other words, the outer surface of the base spring sections 1450a-1450d is substantially perpendicular to the outer surface of the rear spring wall 1444.

The base spring sections 1450a-1450d are positioned between the arched sections 1448a-1448d and the spring arms 1452a-1452h. As shown in FIG. 4, the base spring sections 1450a-1450d are not connected and thus gaps are formed between the base spring sections 1450a-1450d of the spring member 1440c. The gaps aid in omnidirectional expansion of the spring arms 1452a-1452h facilitates the mechanical coupling between the male terminal 1470 and the female terminal assembly 4430. The spring arms 1452a-1452h extend from the base spring sections 1450a-1450d of the spring member 1440c, away from the rear spring wall 1444, and terminate at a free end 1446. The spring arms 1452a-1452h are generally planar and are positioned as such the outer surface of the spring arms 1452a-1452h are co-planar with the outer surface of the base spring sections 1450a-1450d. Unlike the spring arm 31 that is disclosed within FIGS. 4-8 of PCT/US2018/019787, the free end 1446 of the spring arms 1452a-1452h do not have a curvilinear component. Instead, the spring arms 1452a-1452h have a substantially planar outer surface. This configuration is beneficial because it ensures that the forces associated with the spring 1440c are applied substantially perpendicular to the free end 1488 of the male terminal body 1472. In contrast, the curvilinear components of the spring arm 31 are disclosed within FIGS. 4-8 of PCT/US2018/019787 do not apply a force in this manner.

Like the base spring sections 1450a-1450d, the spring arms 1452a-1452h are not connected to one another. In other words, there are spring arm openings that extend between the spring arms 1452a-1452h. This configuration allows for the omnidirectional movement of the spring arms 1452a-1452h, which facilitates the mechanical coupling between the male terminal 1470 and the female terminal assembly 4430. In other embodiments, the spring arms 1452a-1452h may be coupled to other structures to restrict their omnidirectional expansion. The number and width of individual spring arms 1452a-1452h and openings may vary. In addition, the width of the individual spring arms 1452a-1452h is typically equal; however, in other embodiments, one of the spring arms 1452a-1452h may be wider than other spring arms.

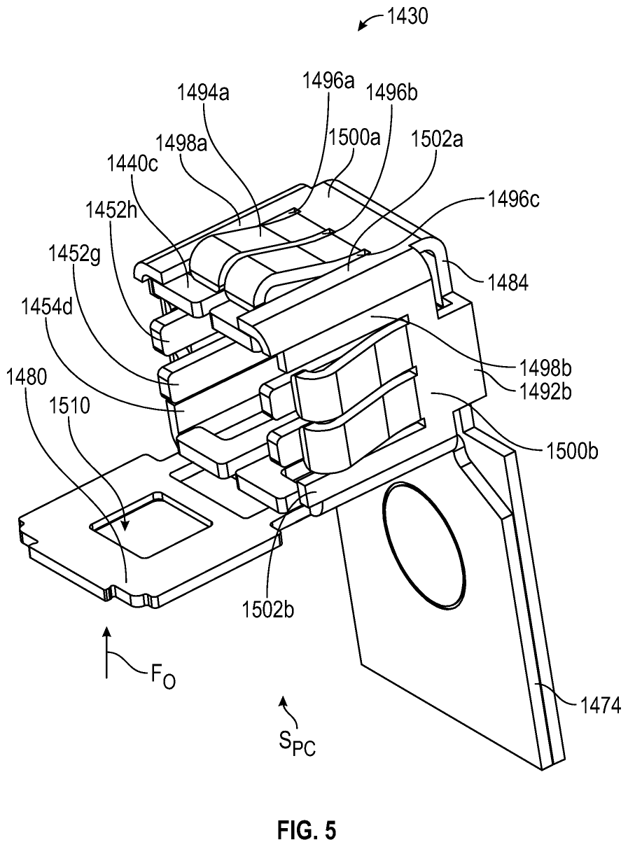

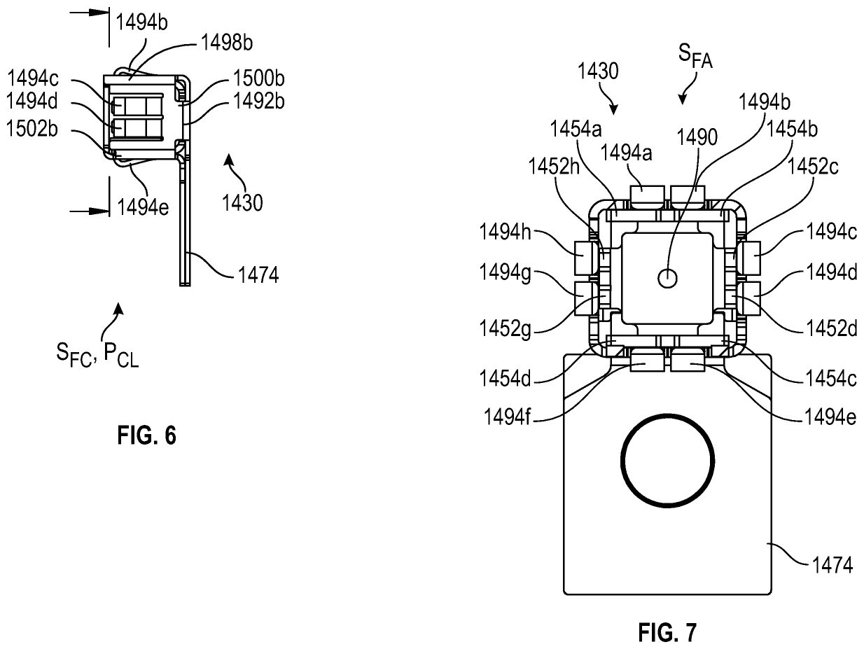

Referring to FIGS. 5-6 of PCT/US2019/36127, a previous design of the spring member 1440pd may not be perfectly aligned within the male terminal body 1472pd of the male terminal assembly 1430pd due to manufacturing tolerances and imperfect assembly methods. As such, the spring member 1440pd may become misaligned or cocked within the male terminal body 1472pd during assembly of the male terminal assembly 1430pd. To help avoid this misalignment, the spring member 1440c disclosed herein includes centering means 1453, which is shown as anti-rotation projections 1454a-1454d. The anti-rotation projections 1454a-1454d help center the spring member 1440c by limiting the amount the spring member 1440c can rotate within the male terminal body 1472 due to the interaction between the outer surface of the projections 1454a-1454d and an inner surface of the side wall portions 1492a-1492d of the male terminal body 1472.

Properly centering the spring member 1440c within the male terminal body 1472, provides many advantages over terminals that are not properly centered or aligned within the male terminal assembly 1430, wherein these advantages include: (i) ensuring that the spring member 1440c applies a proper force on the male terminal body 1472 to provide a proper connection between the male terminal assembly 1430 and the female terminal assembly 4430, (ii) helps improve the durability and useable life of the terminal assemblies 1430, 4430, and (iii) other beneficial features that are disclosed herein or can be inferred by one of ordinary skill in the art from this disclosure.

It should be understood that is other embodiments the centering or alignment means 1453 may take other forms, such as: (i) projections that extend outward from the first and second spring arms 1452a, 1452b that are positioned within a single side wall, (ii) projections that extend outward from the first and fifth spring arms 1452a, 1452e, wherein the projections are situated diagonally opposite from one another, (iii) projections that extend outward from all spring arms 1452a-1452h, wherein the projections associated with 1452c, 1452d, 1452g, 1452h are offset positional relationship in comparison to the projections associated with 1452a, 1452b, 1452e, 1452f, (iv) projections that extend inward from the inside walls of the male terminal body 1472, (v) projections that extend inward towards the center of the connector from the contact arms 1494a-1494h, (vi) cooperative dimensioned spring retainer, (vii) projections, tabs, grooves, recesses, or extents of other structures that are designed to help ensure that the spring member 1440c is centered within the male terminal body 1472 and cannot rotate within the spring receiver 1486. For example, a projection may extend from the front or rear walls of the male terminal body 1472 and they may be received by an opening formed within the spring member 1440c.

It should further be understood that instead of utilizing a mechanical centering or alignment means 1453, the centering means 1453 may be force based, wherein such forces that may be utilized are magnetic forces or chemical forces. In this example, the rear wall of the spring member 1440c may be welded to the rear wall of the male terminal body 1472. In contrast to a mechanical or force based centering means 1453, the centering means 1453 may be a method or process of forming the male terminal assembly 1430. For example, the centering means 1453 may not be a structure, but instead may simultaneous printing of the spring member 1440c within the male terminal body 1472 in a way that does not require assembly. In other words, the centering means 1453 may take many forms (e.g., mechanical based, force based, or process based) to achieve the purpose of centering the spring member 1440c within the male terminal body 1472.

The internal spring member 1440c is typically formed from a single piece of material (e.g., metal); thus, the spring member 1440c is a one-piece spring member 1440c or has integrally formed features. In particular, the following features are integrally formed: (i) the arched spring section 1448a-1448d, (ii) the base spring section 1450a-1450d, (iii) the spring arm 1452a-1452h, and (iv) the centering means 1453. To integrally form these features, the spring member 1440c is typically formed using a die forming process. The die forming process mechanically forces the spring member 1440c into shape. As discussed in greater detail below and in PCT/US2019/036010, when the spring member 1440c is formed from a flat sheet of metal, installed within the male terminal 1472 and connected to the female receptacle 2472, and is subjected to elevated temperatures, the spring member 1440c applies an outwardly directed spring thermal force S_{TF} on the contact arms 1494a-1494h due in part to the fact that the spring member 1440c attempts to return to a flat sheet. However, it should be understood that other types of forming the spring member 1440c may be utilized, such as casting or using an additive manufacturing process (e.g., 3D printing). In other embodiments, the features of the spring member 1440c may not be formed from a one-piece or be integrally formed, but instead formed from separate pieces that are welded together.

In an alternative embodiment that is not shown, the spring member 1440c may include recesses and associated strengthening ribs. As discussed in PCT/US2019/036010, these changes to the configuration of the spring member 1440c alter the forces that are associated with the spring 1440c. In particular, the spring biasing force S_{BF} is the amount of force applied by the spring member 1440c to resist the inward deflection of the free end 1446 of the spring member 1440c when the male terminal assembly 1430 is inserted within the female terminal assembly 4430. Specifically, this inward deflection occurs during the insertion of the male terminal assembly 1430 because the extent of the outer surface of the male terminal body 1472 is slightly larger than the interior of the female receptacle 2472. Thus, when the male terminal assembly 1430 is inserted into the female terminal assembly 4430, the extent of the outer surface is forced towards the center 1490 of the male terminal 1470. This inward force on the outer surface displaces the free end 1446 of the spring member 1440c inward (i.e., towards the center 1490). The spring member 1440c resists this inward displacement by providing a spring biasing force S_{BF}.

### 2. Male Terminal

FIGS. 2-7, 14-18, 20, 22, and 28-31 shows a supply male terminal 1470 that includes the male terminal body 1472 and a male terminal connection plate 1474. Specifically, the male terminal connection plate 1474 is coupled to the male terminal body 1472 and is configured to receive an extent of a structure (e.g., lead or wire) that connects the male terminal assembly 1430 to a device (e.g., an alternator) outside of the connector system 100. The wire 1495 is typically welded to the connection plate 1474; however, other methods (e.g., forming the wire 1495 as a part of the connection plate 1474) of connecting the wire 1495 to the connection plate 1474 are contemplated by this disclosure.

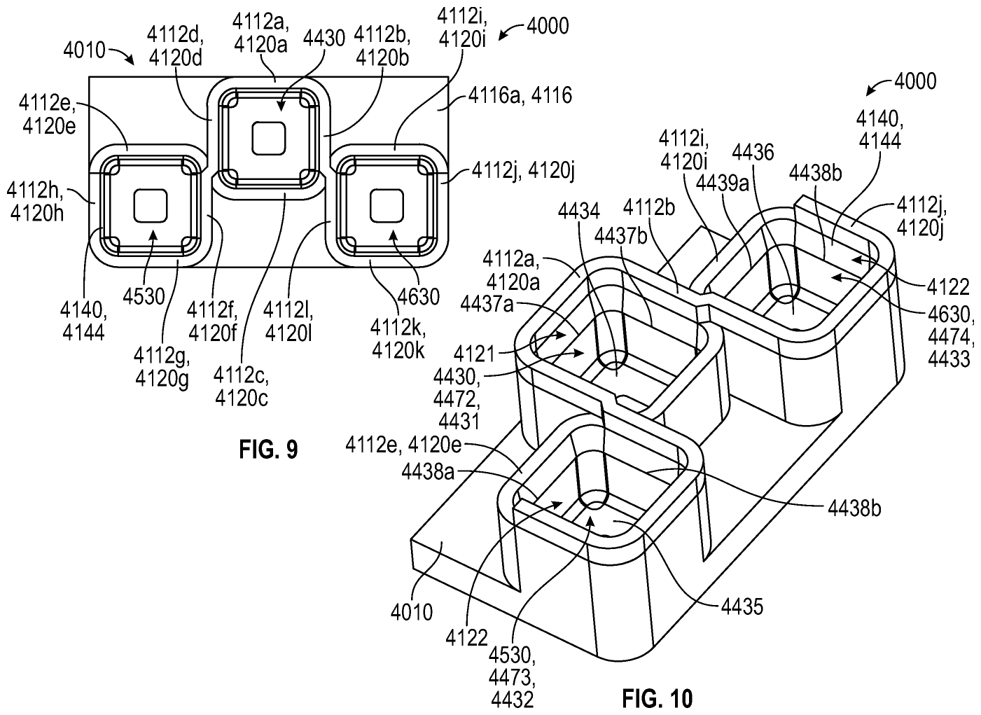

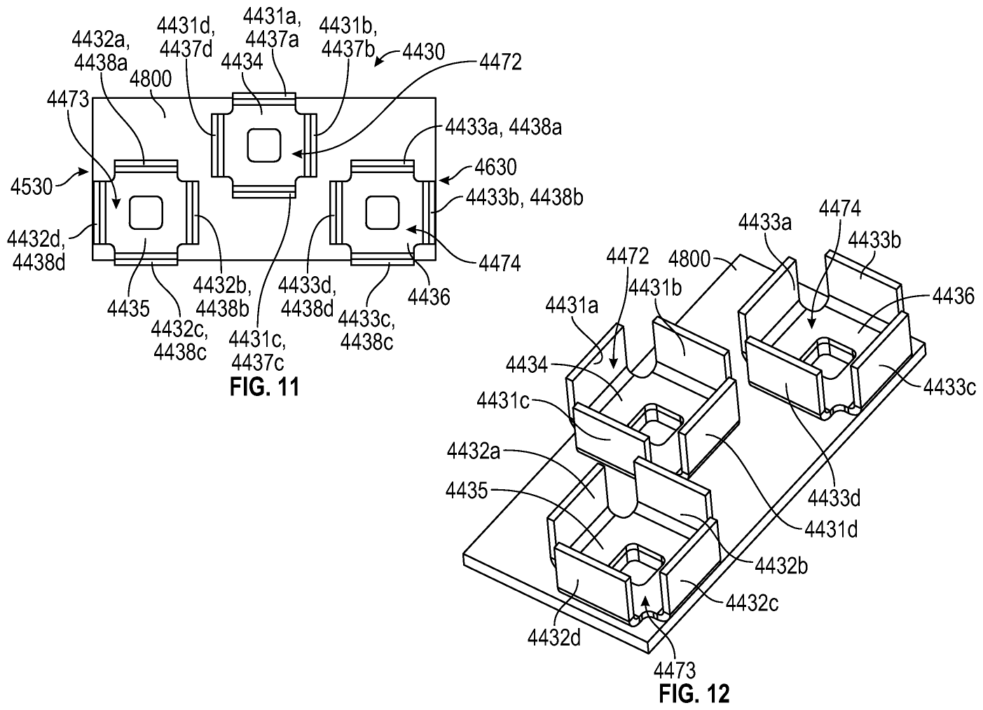

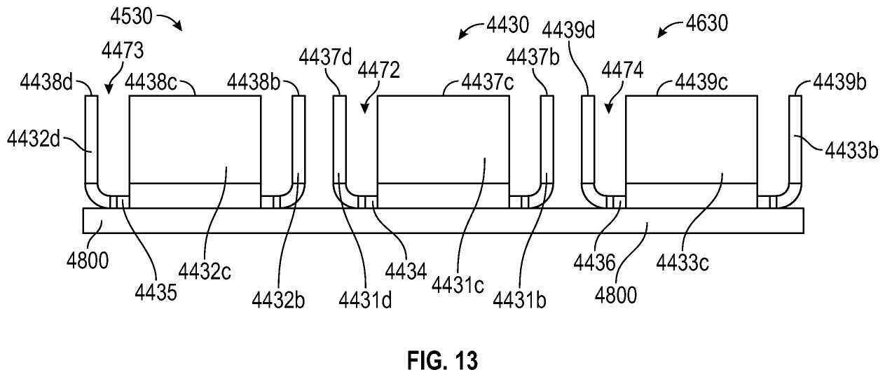

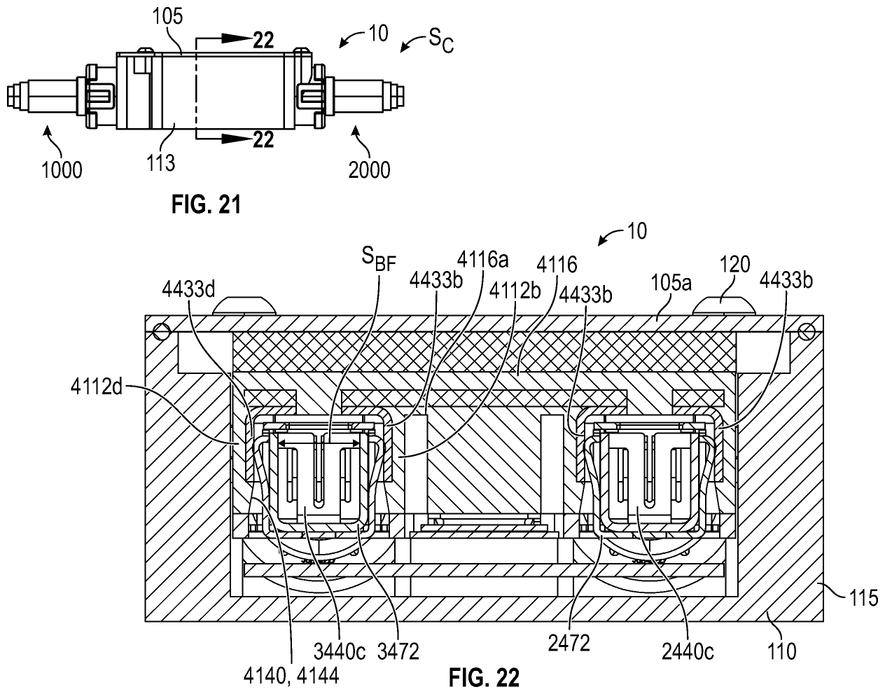

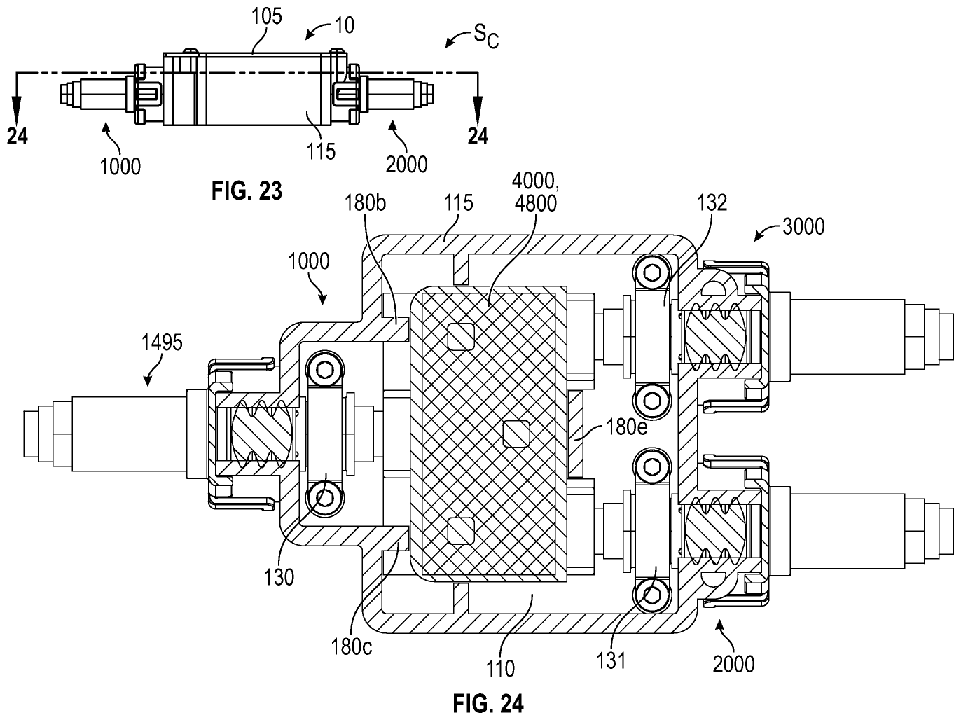

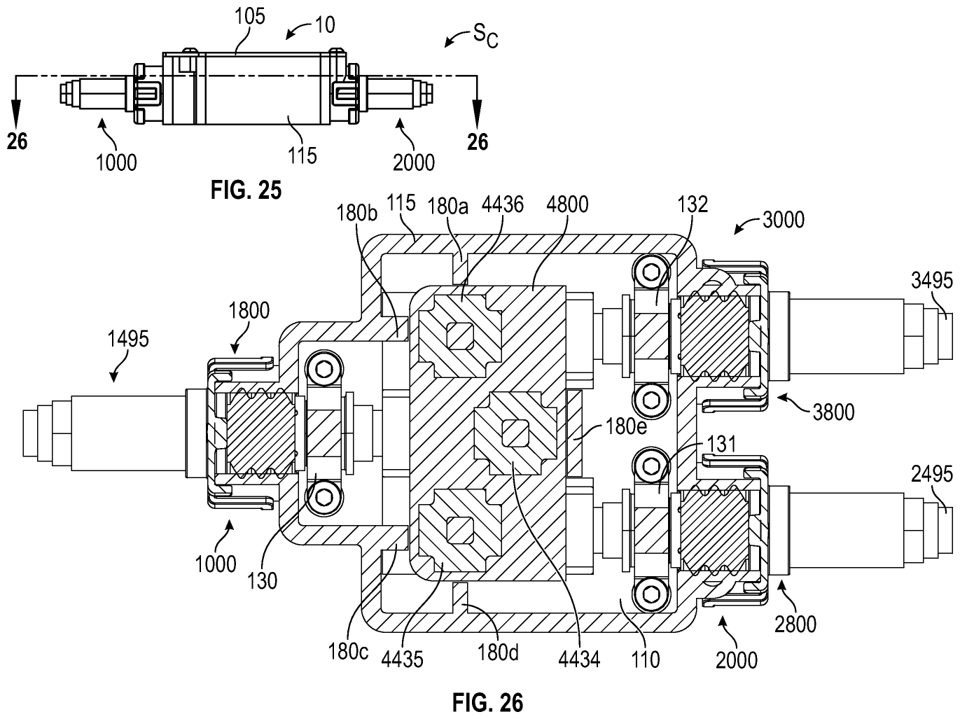

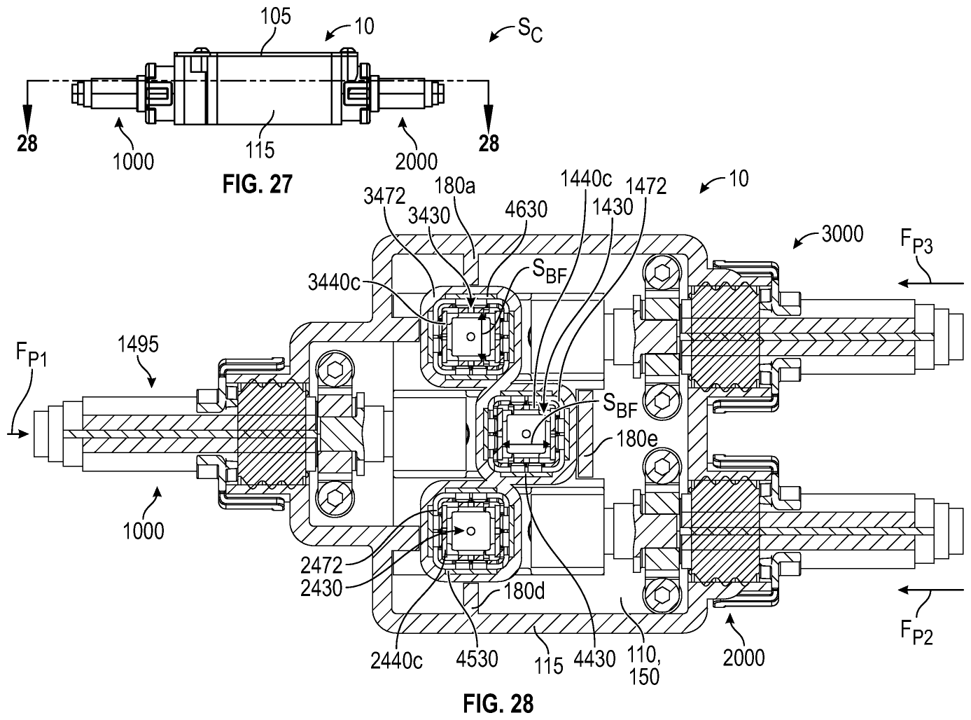

As shown in FIGS. 2-7, 14-18, 20, 22, and 28-31 the arrangement of male terminal side walls 1482a-1482d are coupled to one another and generally form a rectangular prism. The arrangement of male terminal side walls 1482a-1482d includes: (i) a side wall portion 1492a-1492d, which generally has a “U-shaped” configuration, (ii) contact arms 1494a-1494h, and (iii) a plurality of contact arm openings 1496a-14961. As best shown in FIGS. 4-7, the side wall portions 1492a-1492d are substantially planar and have a U-shaped configuration. The U-shaped configuration is formed from three substantially linear segments, wherein a second or intermediate segment 1500a-1500d is coupled on one end to a first or end segment 1498a-1498d and on the other end to a third or opposing end segment 1502a-1502d. The contact arms 1494a-1494h extend: (i) from an extent of the intermediate segment 1500a-1500d of the side wall portion 1492a-1492d, (ii) away from the rear male terminal wall 1484, (iii) across an extent of the contact arm openings 1496a-14961, and (iv) terminate just short of the front male terminal wall 1480. This configuration is beneficial over the configuration of the terminals shown in FIGS. 9-15, 18, 21-31, 32, 41-42, 45-46, 48 and 50 in PCT/US2018/019787 because it allows for: (i) can be shorter in overall length, which means less metal material is needed for the formation and the male terminal 1470 can be installed in narrower, restrictive spaces, (ii) has a higher current carrying capacity, (iii) is easier to assemble, (iv) improved structural rigidity because the contact arms 1494a-1494h are positioned inside of the first male terminal side wall portion 1492a-1492d, (iv) benefits that are disclosed in connection with PCT/US2019/036010, and (v) other beneficial features that are disclosed herein or can be inferred by one of ordinary skill in the art from this disclosure.

As shown in FIGS. 16 and 28, an outer surface of the side wall portion 1492a-1492d, 2492a-2492d, 3492a-3492d is positioned: (i) substantially parallel to an extent of the inner surface of the side wall arrangement 115, and (ii) substantially perpendicular to an inner surface 110b of the bottom wall 110 and an inner cover surface 105c. Additionally, the outer surface of the side wall portion 2492a, 3492a and the outer surface of the side wall portion 2492c, 3492c are substantially co-planar. Moreover, an outer surface of the front male terminal walls 1480, 2480, 3480 is positioned: (i) substantially perpendicular to an extent of the inner surface of the side wall arrangement 115, and (ii) substantially parallel with inner surface of the bottom wall 110 and the inner surface 105c of the cover 105a. Further, it should be understood that the outer surfaces of the front male terminal walls 1480, 2480, 3480 are substantially co-planar.

The contact arm openings 1496a-14961 are integrally formed with the intermediate portion 1500a-1500d of the male terminal side walls 1482a-1482d. The contact arm openings 1496a-14961 extend along the lateral length of the contact arms 1494a-1494h in order to create a configuration that permits the contact arms 1494a-1494h not to be laterally connected to: (i) another contact arm 1494a-1494h or (ii) a structure other than the extent of the male terminal side wall portion 1492a-1492d to which the contact arms 1494a-1494h are coupled thereto. Additionally, the contact arm openings 1496a-14961 align with the spring arm openings. This configuration of openings forms the same number of spring arms 1452a-1452h as the number of contact arms 1494a-1494h. In other words, FIGS. 4-7 show eight spring arms 1452a-1452h and eight contact arms 1494a-1494h. It should be understood that in other embodiments, the number of spring arms 1452a-1452h may not match the number of contact arms 1494a-1494h. For example, there may be fewer spring arms 1452a-1452h.

The contact arms 1494a-1494h extend away from the rear male terminal wall 1484 at an outward angle. In particular, the outward angle may be between 0.1 degree and 16 degrees between the outer surface of the extent of the male terminal side wall 1492a-1492d and the outer surface of the first extent of the contact arms 1494a-1494h, preferably between 5 degrees and 12 degrees and most preferably between 7 degrees and 8 degrees. This outward angle is shown in multiple figures, but may be best visualized in connection with FIGS. 7 and 10. This configuration allows the contact arms 1494a-1494h to be deflected or displaced inward and towards the center 1490 of the male terminal 1470 by the female receptacle 2472, when the male terminal assembly 1430 is inserted into the female terminal assembly 4430. This inward deflection is best shown in FIGS. 31, which is evidenced by the gap 1550. This inward deflection helps ensure that a proper mechanical and electrical connection is created by ensuring that the contact arms 1494a-1494h are placed in contact with the female receptacle 2472.

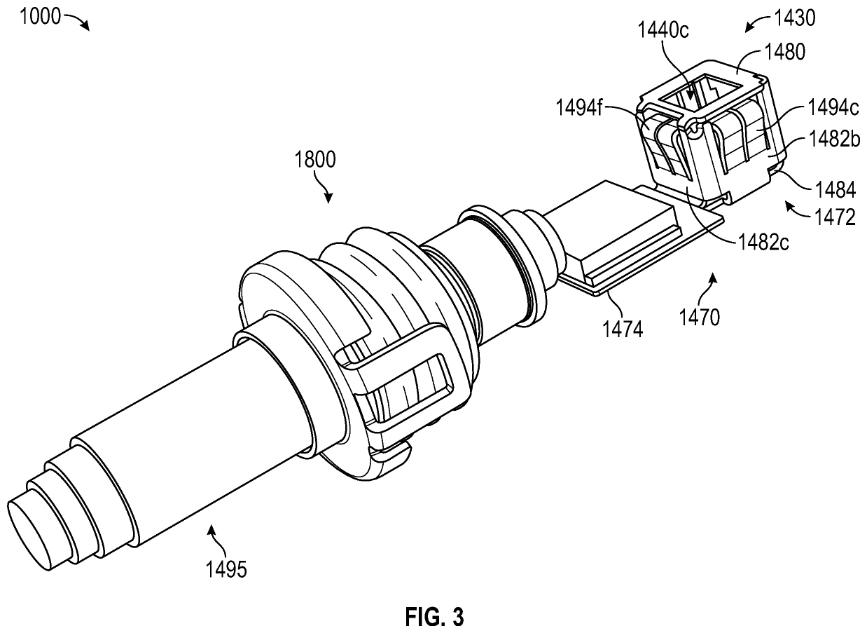

As shown in FIGS. 4-7, the terminal ends of the contact arms 1494a-1494h are positioned: (i) within an aperture formed by the U-shaped side wall portions 1492a-1492d, (ii) substantially parallel to the male terminal side wall 1492a-1492d, and (iii) in contact/abut the planar outer surface of the spring arms 1452a-1452h, when the spring member 1440c is inserted into the spring receiver 1486. This configuration is beneficial over the configuration shown in FIGS. 3-8 in PCT/US2018/019787 because the assembler of the male terminal assembly 1430 does not have to apply a significant force in order to deform a majority of the contact arms 1494a-1494h outward to accept the spring member 1440c. This required deformation can best be shown in FIG. 6 of PCT/US2018/019787 due to the slope of the contact arm 11 and the fact the outer surface of the spring arm 31 and the inner surface of the contact arm 11 are adjacent to one another without a gap formed there between. In contrast to FIGS. 3-8 in PCT/US2018/019787, FIG. 7 of the present application shows a tiny gap formed between the outer surfaces of the spring member 1440c and the inner surface of the contact arms 1494a-1494h. Accordingly, very little force is required to insert the spring member 1440c into the spring receiver 1486 due to the fact the assembler does not have to force the contact arms 1494a-1494h to significantly deform during the insertion of the spring 1440c.

The male terminal 1470 is typically formed from a single piece of material (e.g., metal); thus, the male terminal 1470 is a one-piece male terminal 1470 and has integrally formed features. To integrally form these features, the male terminal 1470 is typically formed using a die-cutting process. However, it should be understood that other types of forming the male terminal 1470 may be utilized, such as casting or using an additive manufacturing process (e.g., 3D printing). In other embodiments, the features of the male terminal 1470 may not be formed from a one-piece or be integrally formed, but instead formed from separate pieces that are welded together. In forming the male terminal 1470, it should be understood that any number (e.g., between 1 and 100) of contact arms 1494a-1494h may be formed within the male terminal 1470.

### 3. Positioning the Spring Member in the Male Terminal Body

Positioning the internal spring member 1440c within the male terminal assembly 1430 occurs across multiple steps or stages. FIG. 4 provides the first embodiment of the male terminal assembly 1430 in a decoupled state S_{DC}, FIG. 5 provides the first embodiment of the male terminal assembly 1430 in a partially coupled state S_{PC}, and FIG. 6 provides the first embodiment of the male terminal assembly 1430 in a fully coupled state S_{FC}. The first stage of assembling the male terminal assembly 1430 is shown in FIG. 4, where the front male terminal wall 1480 is in an open or flat position P_{O} and the spring member 1440c is separated from the male terminal 1470. In this open position P_{O}, the front male terminal wall 1480 is substantially co-planar with the male terminal side wall 1482c. This configuration of the male terminal 1470 exposes the spring receiver 1486 and places the male terminal 1470 in a state that is ready for receiving the spring member 1440c. The second stage of assembling the male terminal assembly 1430 is shown in FIG. 5, where the front male terminal wall 1480 remains in the open or horizontal position P_{O} and the spring member 1440c is positioned within or inserted into the spring receiver 1486. To reach the inserted state, an insertion force, F_{I}, has been applied to the spring member 1440c to insert the spring member 1440c into the spring receiver 1486. The insertion force, F_{I}, is applied on the spring member 1440c until the second or rear male terminal wall 1484 is positioned adjacent to the rear spring wall 1444, a free end 1488 of the male terminal 1470 is substantially aligned with a free end 1446 of the spring member 1440c, and a portion of the male terminal side walls 1482a-1482d are positioned adjacent a portion of the spring member side walls 1442a-1442d.

The third stage of assembling the male terminal assembly 1430 is shown in FIG. 6, where: (i) the front male terminal wall 1480 is closed or vertical P_{CL} and (ii) the spring member 1440c is positioned within the spring receiver 1486. To close the front male terminal wall 1480, an upward directed force, F_{U}, is applied to the male terminal wall 1480 to bend it about its seam to place it adjacent to the side walls 1482a-1482d. After the front male terminal wall 1480 is in the proper position, the top edge is coupled (e.g., welded) to the side wall 1480 of the male terminal body 1472. Here, the closed or vertical P_{CL} of the front male terminal wall 1480 ensures that the spring member 1440c is retained within the male terminal 1470. It should be understood that in other embodiments, the front male terminal wall 1480 may be omitted, may not have a touch proof post opening there through, may not extend the entire way from side wall 1482a-1482d (e.g., partially extending from any side wall 1482a-1482d), or may be a separate piece that is coupled to both side walls 1482a-1482d.

### 4. Strain Relief Assembly

A strain relief assembly 1800 includes multiple components, such as a strain relief cap 1810, which are design to relieve any strain arising from the connection between the male terminal assembly 1430 and the wire 1495. Additional details about this strain relief assembly are disclosed in PCT/US2019/36070, which is fully incorporated herein by reference.

### IV. Receiver Male Connector Assemblies

The second or receiver male connector assembly 2000 and the third or receiver male connector assembly 3000 receive current and primarily comprise: (i) receiver male terminal assemblies 2430, 3430, and (iii) the strain relief assemblies 2800, 3800. As shown in FIGS. 2, 14-18, 22, 28 and 29, the receiver male terminal assemblies 2430, 3430 have the same configuration as the supply male terminal assembly 1430. As such, it should be understood that reference numbers shown in the figures may be omitted from the specification for the sake of brevity as like structures have like numbers. For example, the disclosure concerning the spring member 1440c is not repeated herein, but it applies to spring member 2440c, 3440c as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference.

While the male terminal assemblies 1430, 2430, 3430 are shown having the same configuration, it should be understood that in other embodiments the male terminal assemblies 1430, 2430, 3430 may have different configurations. For example, the male terminal assemblies may be any terminal assembly disclosed within PCT applications PCT/US18/19787, PCT/US19/36010, PCT/US21/43788, PCT/US21/47180, PCT/US21/43686, PCT/US22/37508, PCT/US20/49870, PCT/IB22/61786, PCT/EP22/25551. As discussed above and shown herein, there may be more than one receiver male terminal assemblies 2430, 3430 coupled to a single supply male terminal assembly 1430. Alternatively, a single receiver male terminal assembly may be coupled to multiple supply male terminal assemblies 1430. While the receiver male terminal assemblies 2430, 3430 may be coupled to a busbar or any other type of electrical transporting member.

### V. Mating Assembly

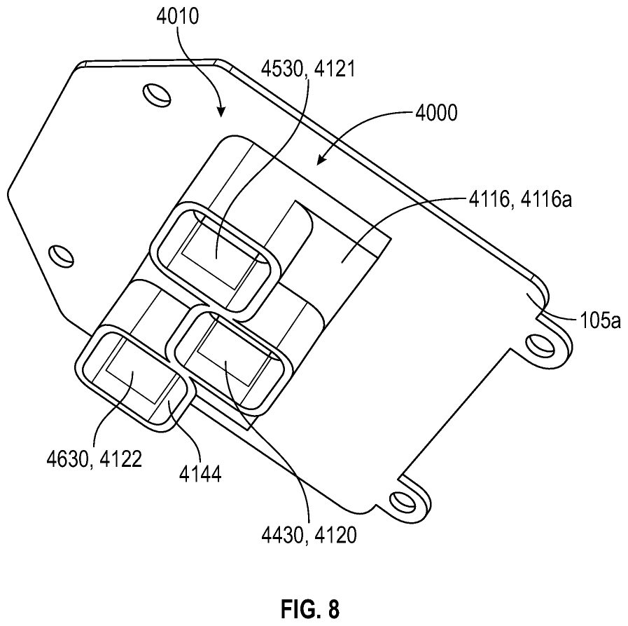

The mating assembly 4000 of the system 10 is designed to electrically coupled the male connector assemblies 1000, 2000, 3000 in the connected state S_{C}. Referring generally to FIGS. 8-13, the mating assembly 4000 primarily comprises: (i) an internal female housing assembly 4010, (ii) a plurality of female terminal assemblies 4430, 4530, 4630, and (iii) an internal current distribution component, such as bridge 4800, which is configured to electrically couple the female terminal assemblies 4430, 4530, 4630 to one another. To facilitate electrical coupling of the male connector assemblies 1000, 2000, 3000, the mating assembly 4000, namely the internal female housing assembly 4010, is directly coupled to an upper extent 105, namely the lid 105a, of the external housing 100. Said mating assembly 4000 is designed to positioned within the external housing 100 in the connected state S_{C}. It should be understood in other embodiments that the mating assembly 4000 may not be affixed (i.e., a separate piece) to the upper extent 1050 or lid 105a of the external housing 100.

The internal female housing assembly 4010 includes a bridge housing 4116 and is designed to: (i) receive and secure the female terminal assemblies 4430, 4530, 4630, (ii) facilitate the coupling of the male terminal assembly 1430 with the female terminal assemblies 4430, 4530, 4630, (iii) minimize the chance that a foreign object accidentally makes contact with the female terminal assemblies 4430, 4530, 4630, and (iv) meet industry standards, such as USCAR specifications. In the Figures, the internal female housing assembly 4010 includes a three-part wall arrangement 2110 having twelve integrally formed sidewalls 4112a-41121. The sidewalls 4112a-41121 extend upward from the upper surface 4116a of a bridge housing 4116 and form receivers with configurations that substantially matches the configuration of each of the female terminal assemblies 4430, 4530, 4630. In the embodiment shown in the Figures, the female terminal assemblies 4430, 4530, 4630 have cuboidal configurations and thus the sidewalls 4112a-41121 have a linear configuration and form a cuboidal receiver 4121, 4122, 4123. However, it should be understood that alterations to the shape of the female terminal assemblies 4430, 4530, 4630 (e.g., use of a cylindrical terminal) may require that the shape and configuration of the sidewalls 4112a-41121 be altered to mirror the shape of the terminal (e.g., hollow cylinder).

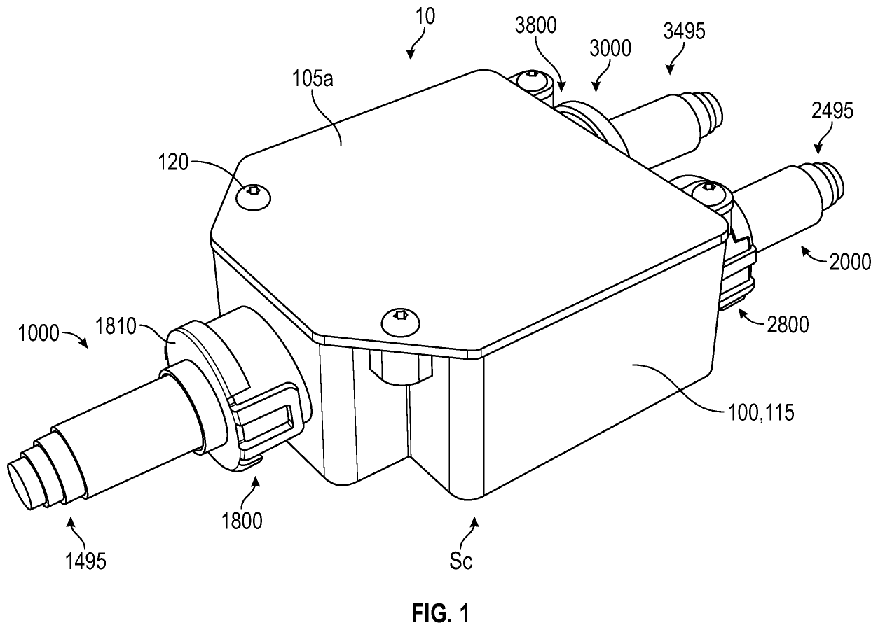

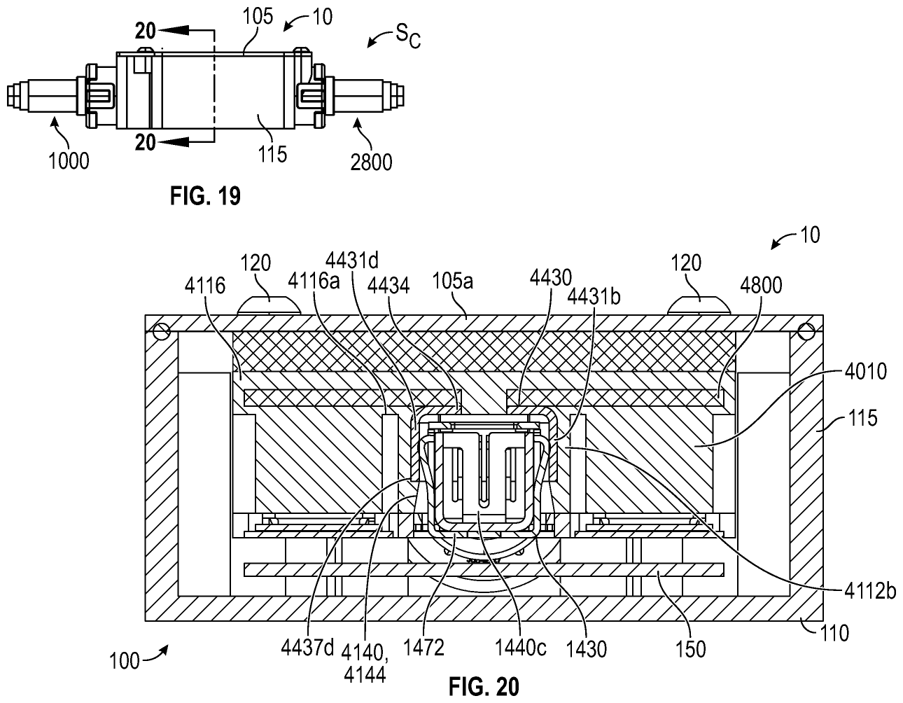

As shown in at least FIGS. 8-20, the sidewalls 4112a-41121 have a height greater than the height of the female terminal assemblies 4430, 4530, 4630. The delta between these heights allows for the sidewalls 4112a-41121 to include at least one male compression means 4140. Referring to FIGS. 9 and 10, the male compression means 4140 is a sloped or ramped compression surface 4144 that extends from a outermost edges 4120a-41201 of the sidewalls 4112a-41121 to the upper most edges 4437a-4437d, 4438a-4438d, 4439a-4439d of the female terminal assemblies 4430, 4530, 4630. In the disclosed embodiment, the sloped or ramped surface 4144 extends from each of the outermost edges 4120a-41201 and has a substantially linear configuration. However, it should be understood that the sloped or ramped surface 4144 may only extend from one or two of the outermost edges 4120a-41201. The male compression means 4140, and the sloped or ramped surface 4144 shown in the Figures, are designed to compress the contact arms 1494a-1494h, 2494a-2494h, 3494a-3494h as the male terminal assemblies 1430, 2430, 3430 moves from being separated from the female terminal assembly 4430, 4530, 4630 in a disconnected state S_{DCON} to being positioned within an extent of the female terminal assemblies 4430, 4530, 4630 in a connected state S_{C} with the application of a sufficient coupling force F_{C} (see FIGS. 1 and 19-31). As such, the distance between opposed outermost edges 4120a-41201 is equal to a sidewall distance that is greater than the rearmost edge distance that extends between opposed rearmost edges 4124a-41241 of the sloped or ramped surface 4144. The rearmost edge distance is greater than or equal to a receiver distance that extends between opposed inner surfaces of the receptacles 4472, 4473, 4474 of the female terminal assemblies 4430, 4530, 4630. In particular, the sidewall distance is between 0.1% and 15% larger than the receiver distance, and where the receiver distance is equal to or between 0.1% and 3% larger than the rearmost edge distance. In other words, the sloped or ramped surface 4144 is angled relative to the outer surface of the sidewalls 4112a-41121 and/or the inner surfaces of the receptacles 4472, 4473, 4474 of the female terminal assemblies 4430, 4530, 4630. In particular, the interior angle that extends between the inner surface of the sloped or ramped surface 4144 and the outer surface of the sidewalls 4112a-41121 is between 0.1 degrees and 10 degrees.

This sloped or ramped surface 4144 is made from a polymer or plastic material and, as such has a coefficient of friction that is lower than a coefficient of friction associated with a metal surface. In other words, a first friction value is formed when the extent (e.g., a contact arm 1494a-1494h, 2494a-2494h, 3494a-3494h) of the male terminal assemblies 1430, 2430, 3430 engages with a male terminal compression means 4140 formed from a non-metallic material (e.g., plastic). In an alternative embodiment, a second friction value would be formed if the extent (e.g., a contact arm 1494a-1494h, 2494a-2494h, 3494a-3494h) of the male terminal assemblies 1430, 2430, 3430 was to engage with a male terminal compression means formed from a metallic material (e.g., copper). Comparing the friction values, it should be understood that the first friction value is less than the second friction value.

The lower coefficient of friction reduces the force that is required to insert the male terminal assemblies 1430, 2430, 3430 into the female terminal assemblies 4430, 4530, 4630. This is beneficial to the performance of the system 10 because: (i) industry specifications, including USCAR 25, has requirements that the insertion force cannot be greater than 45 Newtons for a Class 2 connector and 75 Newtons for a Class 3 connector and (ii) the use of a greater spring biasing force, which thereby increases the insertion force, is desirable to help ensure that the contact arms of the male terminal assembly remain in contact with the inner surfaces of the receptacles 4472, 4473, 4474 of the female terminal assemblies 4430, 4530, 4630. Further, this lower coefficient of friction is beneficial because the system 10 can move from the disconnected state S_{DCON} to a connected state S_{C} while meeting Class 2/Class 3 of the USCAR specifications without requiring a handle or lever assist. Eliminating the handle or lever assist reduces the size, weight, and cost of manufacturing the system 10. It should be understood that to further reduce the coefficient of friction, the sloped or ramped surface 4144 may be coated with a substance that further reduces the friction coefficient, or the sloped or ramped surface 4144 may be made from a material that has an even lower coefficient of friction.

Due to the configuration of the male connector assemblies 1000-3000 and the mating assembly 4000, the coupling force F_{C} includes multiple components, primarily due to different sliding engagements, as the system 10 moves from the disconnected state S_{DCON} to the connected state S_{C}. For example, a first component of the coupling force F_{C} is required to move the male terminal assemblies 1430, 2430, 3430 when an extent—namely, a contact arm 1494a-1494h, 2494a-2494h, 3494a-3494h—of the male terminal assemblies 1430, 2430, 3430 is in sliding engagement with the male terminal compression means 4140. A second component of the coupling force F_{C} is required to move the male terminal assemblies 1430, 2430, 3430 when the extent—namely, a contact arm 1494a-1494h, 2494a-2494h, 3494a-3494h—of the male terminal assemblies 1430, 2430, 3430 is positioned in the female terminal receptacles 4472, 4473, 4474. Due to the structural and positional arrangement of the system 10, the magnitude of the second component of the coupling force F_{C} is less than the magnitude of the first component of the coupling force F_{C}. The difference in the magnitudes of the first and second components of the coupling force F_{C} is beneficial because it provides the user with tactile feedback that notifies the user/operator/installer that each of the male terminal assemblies 1430, 2430, 3430 is correctly seated within the respective the female terminal assemblies 4430, 4530, 4630. In fact, this tactile feedback gives an impression to the user/operator/installer that the male terminal assemblies 1430, 2430, 3430 are being pulled further into the housing 110 or drawn towards the female terminal assemblies 4430, 4530, 4630, which facilitates proper connectivity. Additional information about the components of the coupling force F_{C} is disclosed within PCT/US19/36010, which again is fully incorporated herein by reference.

The female terminal assemblies 4430, 4530, 4630 of the mating assembly 4000 include a female terminal body which comprises a plurality of sidewalls 4431a-4431d, 4432a-4432d, 4433a-4433d that are integrally formed with a rear wall 4434, 4435, 4436. Each of the sidewalls 4431a-4431d, 4432a-4432d, 4433a-4433d and rear wall 4434, 4435, 4436 have inner surfaces, whose combination forms cuboidal terminal receptacles 4472, 4473, 4474. These cuboidal terminal receptacles 4472, 4473, 4474 have a receiver distance that extends between the inner surfaces of opposed sidewalls 4431a-4431d, 4432a-4432d, 4433a-4433d. As discussed above, the receiver distance is: (i) less than the sidewall distance and (ii) equal to or greater than the rearmost edge distance. Additionally, the receiver distance is between 0.1% and 15% smaller than a male terminal assembly distance that extends between the outermost extents of opposed contact arms 1494a-1494h, 2494a-2494h, 3494a-3494h. Forming the terminal receptacles 4472, 4473, 4474 with a receiver distance that is less than the male terminal assembly distance ensures that the contact arms 1494a-1494h, 2494a-2494h, 3494a-3494h are compressed when the male terminal assemblies 1430, 2430, 3430 are inserted into the female terminal assemblies 4430, 4530, 4630. This compression of the male terminal assemblies 1430, 2430, 3430 also leads to compression of the internal spring member 1440c, 2440c, 3440c. As such, the spring member 1440c, 2440c, 3440c exerts an outwardly directed biasing force on the contact arms 1494a-1494h to help ensure that they remain in contact with the inner surfaces of the terminal receptacles 4472, 4473, 4474 in order to facilitate the electrical and mechanical coupling of the male terminal assemblies 1430, 2430, 3430 with the female terminal assemblies 4430, 4530, 4630.

As shown in FIGS. 16 and 28, an outer surface of the sidewall 4431a-4431d, 4432a-4432d, 4433a-4433d is positioned: (i) substantially parallel to an extent of the inner surfaces of the side wall arrangement 115, and (ii) substantially perpendicular with inner surface 110b of the bottom wall 110 and cover 105a. Additionally, the outer surface of the sidewalls 4432a, 4433a and the outer surface of the sidewalls 4432c, 4433c are substantially co-planar. Moreover, an outer surface of the rear wall 4434, 4435, 4436 are positioned: (i) substantially perpendicular to the inner surfaces of the side wall arrangement 115, and (ii) substantially parallel with the inner surface 110b of the bottom wall 110 and the inner surface 105c of the cover 105a. Further, it should be understood that the outer surfaces of the rear wall 4434, 4435, 4436 are substantially co-planar.

The female terminal assemblies 4430, 4530, 4630 are typically formed from metal and preferably a highly conductive metal, such as copper. The female terminal assemblies 4430, 4530, 4630 may be plated or clad with Ni—Ag. As shown in the Figures, the sidewalls 4431a-4431d, 4432a-4432d, 4433a-4433d are not be integrally formed with one another and instead are only integrally formed with the rear wall 4434, 4435, 4436. In other embodiments, the female terminal assemblies 4430, 4530, 4630 may have integrally formed sidewalls 4431a-4431d, 4432a-4432d, 4433a-4433d, the sidewalls 4431a-4431d, 4432a-4432d, 4433a-4433d may be made from a different material, and/or the female terminal assemblies 4430, 4530, 4630 may not be plated or clad with Ni—Ag.

The bridge or bus 4800 has a substantially co-planar configuration and is designed to electrically interconnect the female terminal assemblies 4430, 4530, 4630 to one another. The bridge 4800 is coupled to the rear walls 4434, 4435, 4436 of the female terminal assemblies 4430, 4530, 4630 and is indirectly attached to the inner surface 105c of the cover 105a. The bridge 4800 is made from a conductive material (e.g., copper). The bridge 4800 is positioned in the bridge housing 4116, wherein said bridge housing 4116 is configured to isolate the bridge 4800 from the external housing 100.

### VI. Terminal Properties and Functionality

FIG. 31 depicts a cross-section of the male connector assembly 1000 coupled to the extent of the mating assembly 4000 in the connected state S_{C}. The male terminal body 1472, including the contact arms 1494a-1494d, may be formed from a first material such as copper, a highly-conductive copper alloy (e.g., C151 or C110), aluminum and/or another suitable electrically conductive material. The first material preferably has an electrical conductivity of more than 80% of IACS (International Annealed Copper Standard, i.e., the empirically derived standard value for the electrical conductivity of commercially available copper). For example, C151 typically has 95% of the conductivity of standard, pure copper compliant with IACS. Likewise, C110 has a conductivity of 101% of IACS. In certain operating environments or technical applications, it may be preferable to select C151 because it has anti-corrosive properties desirable for high-stress and/or harsh weather applications where the system 10 is installed for use. The first material for the male terminal body 1472 is C151 and is reported, per ASTM B747 standard, to have a modulus of elasticity (Young's modulus) of approximately 115-125 GigaPascals (GPa) at room temperature and a coefficient of terminal expansion (CTE) of 17.6 ppm/degree Celsius (from 20-300 degrees Celsius) and 17.0 ppm/degree Celsius (from 20-200 degrees Celsius).

The spring member 1440c may be formed from a second material such as spring steel, stainless steel (e.g., 301SS, ¼ hard), and/or another suitable material having greater stiffness (e.g., as measured by Young's modulus) and resilience than the first material of the male terminal body 1472. The second material preferably has an electrical conductivity that is less than the electrical conductivity of the first material. The second material also has a Young's modulus that may be approximately 193 GPa at room temperature and a coefficient of terminal expansion (CTE) of 17.8 ppm/degree Celsius (from 0-315 degrees Celsius) and 16.9 ppm/degree Celsius (from 0-100 degrees Celsius). In contemplated high-voltage applications, the cross-sectional area of copper alloy forming the first connector is balanced with the conductivity of the selected copper alloy. For example, when a copper alloy having lower conductivity is selected, the contact arms 1494a-1494d formed therefrom have a greater cross-sectional area so as to adequately conduct electricity. Likewise, selection of a first material having a higher conductivity may allow for contact arms 1494a-1494d having a relatively smaller cross-sectional area while still meeting conductivity specifications.

In an example embodiment, the CTE of the second material may be greater than the CTE of the first material, i.e., the CTE of the spring member 1440c is greater than the CTE of the male terminal body 1472. Therefore, when the assembly of the male terminal body 1472 and the spring member 1440c is subjected to the high-voltage and high-temperature environment typical for use of the electrical connector described in the present disclosure, the spring member 1440c expands relatively more than the male terminal body 1472. Accordingly, the outwardly directed biasing force S_{BF} produced by the spring member 1440c on the contact arms 1494a-1494d of the male terminal body 1472 is increased in accordance with the increased temperature, which is referred to below as a thermal spring force, SIF.

An exemplary installation of the system 10 is with a vehicle alternator in a class 5 automotive environment, such as that found in passenger and commercial vehicles. Class 5 environments are often found under the hood of a vehicle and present 150° Celsius ambient temperatures and routinely reach 200° Celsius. When copper and/or highly conductive copper alloys are subjected to temperatures above approximately 150° Celsius these alloys become malleable and lose mechanical resilience, i.e., the copper material softens. However, the steel forming the spring member 1440c retains hardness and mechanical properties when subjected to similar conditions. Therefore, when the male terminal body 1472 and spring member 1440c are both subjected to high-temperature, the first material of the male terminal body 1472 softens and the structural integrity of the spring member 1440c, formed from the second material, is retained, such that the force applied to the softened contact arms 1494a-1494d by the spring member 1440c more effectively displaces the softened contact arms 1494a-1494d outward relative the interior of the male terminal body 1472, in the connected state S_{C}.

In the connected state S_{C}, one or more outer surfaces of the spring arms 1452a-1452d contact the free ends 1488 of the respective contact arms 1494a-1494d. As discussed above, the outermost extent of the contact arms 1494a-1494d are slightly larger than the inner extent of the female terminal body. As such, when these components are mated with one another, the spring member 1440c is compressed. This compression of the spring member 1440c creates an outwardly directed biasing force S_{BF} against the contact arms 1494a-1494d and away from the interior of the spring member 1440c. This configuration is designed to maintain conductive and mechanical engagement while withstanding elevated temperatures and thermal cycling resulting from high-power, high-voltage applications to which the connector assembly is subjected. Further, the male terminal body 1472 and female terminal body may undergo thermal expansion as a result of the elevated temperatures and thermal cycling resulting from high-voltage, high-temperature applications, which increases the outwardly directed force applied by the male terminal body 1472 on the female terminal body. The configuration of the male terminal body 1472, spring member 1440c, and the female terminal body increase the outwardly directed connective force there between.

Based on the above exemplary embodiment, both the Young's modulus and the CTE of the spring member 1440c are greater than both the Young's modulus and the CTE of the male terminal body 1472. Thus, when the male terminal body 1472 is used in a high power application that subjects the system 10 to repeated thermal cycling with elevated temperatures (e.g., approximately 150° Celsius) then: (i) the male terminal body 1472 become malleable and loses some mechanical resilience, i.e., the copper material in the male terminal body 1472 softens and (ii) the spring member 1440c does not become as malleable or lose as much mechanical stiffness in comparison to the male terminal body 1472.

Thus, when utilizing a spring member 1440c that is mechanically cold formed into shape (e.g., utilizing a die forming process) and the spring member 1440c is subjected to elevated temperatures, the spring member 1440c will attempt to at least return to its uncompressed state, which occurs prior to insertion of the male terminals assemblies 1430, 2430, 3430 within the female terminal assembly 4430, and preferably to its original flat state, which occurs prior to the formation of the spring member 1440c. In doing so, the spring member 1440c will apply a generally outwardly directed thermal spring force S_{TF} (as depicted by the arrows labeled “S_{TF}” in FIG. 31) on the free ends 1488 of the contact arms 1494a-1494d. This thermal spring force S_{TF} is dependent upon local temperature conditions, including high and/or low temperatures, in the environment where the system 10 is installed. Accordingly, the combination of the spring biasing force S_{BF} and the thermal spring force, S_{TF}, provides a resultant biasing force S_{F} that ensures that the outer surface of the contact arms 1494a-1494d is driven or forced into contact with the inner surface of the female terminal body 2434 when the male terminal assemblies 1430, 2430, 3430 are inserted into the female terminal 4430 and during operation of the system 10 to ensure an electrical and mechanical connection. Additionally, with repeated thermal cycling events, the male terminal assemblies 1430, 2430, 3430 will develop an increase in the outwardly directed spring biasing forces S_{F} that are applied to the female terminal assemblies 4430, 4530, 4630 during repeated operation of the system 10.

Further illustrated in FIG. 31, in the connected state S_{C}, the male terminal assemblies 1430, 2430, 3430 provides 360° compliance with the female terminal assembly 4430 to ensure that a sufficient amount of outwardly directed force F is applied by the male terminal assemblies 1430, 2430, 3430 to the female terminal assembly 4430 for electrical and mechanical connectivity in all four primarily directions. This attribute allows for omission of a keying feature and/or another structural feature designed to ensure a desired orientation of the components during connection. The 360° compliance attribute of the system 10 also aids in maintaining mechanical and electrical connection under strenuous mechanical conditions, e.g., vibration. In a traditional blade or fork-shaped connector with 180° compliance, i.e., connection on only two opposing sides, vibration may develop a harmonic resonance that causes the 180° compliant connector to oscillate with greater amplitude at specific frequencies. For example, subjecting a fork-shaped connector to harmonic resonance may cause the fork-shaped connector to open. Opening of the fork-shaped connector during electrical conduction is undesirable because momentary mechanical separation of the fork-shaped connector from an associated terminal may result in electrical arcing. Arcing may have significant negative effects on the 180° compliant terminal as well as the entire electrical system of which the 180° compliant terminal is a component. However, the 360° compliance feature of the present disclosure prevents problematic failures of the system 10 caused by strong vibration and electrical arcing.

### VII. Other Relevant Information

The system 10 is T4/V4/S3/D2/M2 compliant, wherein the system 10 meets and exceeds: (i) T4 is exposure of the system 100 to 150° C., (ii) V4 is severe vibration, (iii) S1 is sealed high-pressure spray, (iv) D2 is 200k mile durability, and (v) M2 is less than 45 Newtons of force is required to connect the male terminal assembly 1430, 2430, 3430 to the female terminal assemblies 4430, 4530, 4630. In addition to being T4/V4/S3/D2/M2 compliant, the system 10 is push, click, tug (PCT) compliant, wherein additional information about this standard is disclosed within PCT/US2020/049870.

It should be understood that the male terminal assemblies 1430, 2430, 3430 and the female terminal assemblies 4430, 4530, 4630 disclosed within this application may be replaced with the male terminal assemblies and the female terminal assemblies disclosed within PCT/US18/19787, PCT/US19/36010, PCT/US21/43788, PCT/US21/47180, PCT/US21/43686, PCT/US22/37508, PCT/US20/49870, PCT/IB22/61786, PCT/EP22/25551, or any other terminal known in the art (e.g., RADSOK, blade, or etc.). Additionally, other performance specifications of the system 10 disclosed herein will be obvious to one of skill in the art.

It should also be understood that the male terminal assemblies may have any number of contact arms 1494, 2494, 3494 (e.g., between 2-100, preferably between 2-50, and most preferably between 2-8) and any number of spring arms 1452, 2452, 3452 (e.g., between 2-100, preferably between 2-50, and most preferably between 2-8). As discussed above, the number of contact arms 1494, 2494, 3494 may not equal the number of spring arms. For example, there may be more contact arms 1494, 2494, 3494 then spring arms 1452, 2452, 3452. Alternatively, there may be less contact arms 1494, 2494, 3494 then spring arms 1452, 2452, 3452.

### MATERIALS AND DISCLOSURE THAT ARE INCORPORATED BY REFERENCE

PCT Application Nos. PCT/EP2022/025574, PCT/IB2022/061786, PCT/EP2022/025551, PCT/US2022/037508, PCT/IB2022/057772, PCT/US2021/057959, PCT/US2021/047180, PCT/US2021/043788, PCT/US2021/043686, PCT/US2021/033446, PCT/US2020/050018, PCT/US2020/049870, PCT/US2020/014484, PCT/US2020/013757, PCT/US2019/036127, PCT/US2019/036070, PCT/US2019/036010, and PCT/US2018/019787, U.S. patent application Ser. No. 16/194,891 and U.S. Provisional Application 63/308,488, each of which is fully incorporated herein by reference and made a part hereof.

SAE Specifications, including: J1742_201003 entitled, “Connections for High Voltage On-Board Vehicle Electrical Wiring Harnesses-Test Methods and General Performance Requirements,” last revised in March 2010, each of which is fully incorporated herein by reference and made a part hereof.

ASTM Specifications, including: (i) D4935-18, entitled “Standard Test Method for Measuring the Electromagnetic Shielding Effectiveness of Planar Materials,” and (ii) ASTM D257, entitled “Standard Test Methods for DC Resistance or Conductance of Insulating Materials,” each of which are fully incorporated herein by reference and made a part hereof.

American National Standards Institute and/or EOS/ESD Association, Inc. Specifications, including: ANSI/ESD STM11.11 Surface Resistance Measurements of Static Dissipative Planar Materials, each of which is fully incorporated herein by reference and made a part hereof.

DIN Specification, including Connectors for electronic equipment—Tests and measurements—Part 5-2: Current-carrying capacity tests; Test 5b: Current-temperature derating (IEC 60512-5-2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

IEC 60529:1989+A1:1999+A2:2013 Applies to the classification of degrees of protection provided by enclosures for electrical equipment with a rated voltage not exceeding 72.5 kV, which was revised on January 2019, which is fully incorporated herein by reference and made a part hereof.

Other standards, including Federal Test Standard 101C and 4046, each of which is fully incorporated herein by reference and made a part hereof.

### INDUSTRIAL APPLICABILITY

While some implementations have been illustrated and described, numerous modifications come to mind without significantly departing from the spirit of the disclosure; and the scope of protection is only limited by the scope of the accompanying claims. For example, the overall shape of the of the components described above may be changed to: a triangular prism, a pentagonal prism, a hexagonal prism, octagonal prism, sphere, a cone, a tetrahedron, a cuboid, a dodecahedron, an icosahedron, an octahedron, a ellipsoid, or any other similar shape.

It should be understood that the following terms used herein shall generally mean the following:
a. “High power” shall mean (i) voltage between 20 volts to 600 volts regardless of current or (ii) at any current greater than or equal to 80 amps regardless of voltage.
b. “High current” shall mean current greater than or equal to 80 amps regardless of voltage.
c. “High voltage” shall mean a voltage between 20 volts to 600 volts regardless of current.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1. A splice block system for use in a power distribution system, the splice block system comprising:
an external housing having a removable cover;
a mating assembly coupled to the removable cover and including a first female terminal assembly, a second female terminal assembly, and a third female terminal assembly;
a first male connector assembly having a first male terminal assembly;
a second male connector assembly having a second male terminal assembly;
a third male connector assembly having a third male terminal assembly;
wherein a positioning force F_{P} is applied to each of the first, second, and third male terminal assemblies in order to cause the system to move from a disassembled state S_{DA} to a fully assembled state S_{FA};
wherein an application of a coupling force F_{C}, that is oriented substantially perpendicular to said positioning force F_{P}, is applied to the removable cover in order to cause the system to move from a disconnected state S_{DCON} to a connected state S_{CON}; and
wherein in the connected state S_{CON}: (i) an extent of the first male terminal assembly is positioned within the first female terminal assembly, (ii) an extent of the second male terminal assembly is positioned within the second female terminal assembly, and (iii) an extent of the third male terminal assembly is positioned within the third female terminal assembly.

2. (canceled)

3. The splice block system of claim 1, wherein the first male terminal assembly includes a front wall that is positioned substantially parallel with the removable cover in the connected state S_{CON}.

4. (canceled)

5. The splice block system of claim 1, wherein, in the connected state S_{CON}, the first female terminal assembly includes a side wall that is positioned substantially parallel with a side wall of the first male terminal assembly; and
wherein said side walls of the first female terminal assembly and the first male terminal assembly are positioned perpendicular to the removable cover.

6. The splice block system of claim 1, wherein the mating assembly includes an internal female housing assembly that is coupled to the removable cover, and
wherein the internal female housing assembly includes: (i) a first receiver that has a cuboidal configuration and is designed to receive the first female terminal assembly, (ii) a second receiver that has a cuboidal configuration and is designed to receive the second female terminal assembly, and (iii) a third receiver that has a cuboidal configuration and is designed to receive the third female terminal assembly.

7. (canceled)

8. The splice block system of claim 1, wherein the mating assembly includes an internal female housing assembly that is coupled to the removable cover, and
wherein the internal female housing assembly includes a male compression means that compresses an extent of the first, second, and third male terminal assemblies when the system moves from the disconnected state S_{DCON} to the connected state S_{CON}.

9. (canceled)

10. The splice block system of claim 8, wherein the male compression means includes a compression surface, and
wherein an angle between 1 degree and 10 degrees is formed between said compression surface and an outer surface of the internal female housing assembly.

11. (canceled)

12. The splice block system of claim 1, wherein the mating assembly includes a bridge that has a substantially planar configuration and is designed to electrically interconnect the first, second, and third female terminal assemblies to one another, and
wherein the mating assembly further includes a bridge housing positioned between the bridge and the removable cover.

13. (canceled)

14. The splice block system of claim 1, wherein the coupling force F_{C} that is required to move from the disconnected state S_{DCON} to the connected state S_{CON} is less than 45 Newtons.

15.-17. (canceled)

18. The splice block system of claim 1, wherein the coupling force F_{C} has: (i) a first force component, and (ii) a second force component that is different from the first force component, and
wherein the difference between the first and second force components provides a user with tactile feedback that notifies the user that each of the first, second, and third male terminal assemblies are positioned within the respective first, second, and third female terminal assemblies.

19. (canceled)

20. (canceled)

21. The splice block system of claim 1, wherein the first male terminal assembly includes a male terminal body having a receiver configured to receive a spring member.

22. The splice block system of claim 21, wherein the first male terminal assembly includes a front wall being movable from: (i) an open position that is configured to receive the spring member in the receiver, to (ii) a closed position that is configured to secure said spring member in the receiver.

23. (canceled)

24. The splice block system of claim 1, wherein the first male terminal assembly includes: (i) a male terminal body having a contact arm with a free end, and (ii) a spring member having a spring arm; and
wherein, when the male terminal assembly is in a fully coupled state S_{FC}, the free end of the contact arm abuts a planar surface of the spring arm.

25. (canceled)

26. The splice block system of claim 1, wherein the first male terminal assembly includes: (i) a male terminal body having a contact arm, and (ii) a spring member having a spring arm; and
wherein:
i) in the connected state S_{CON}, the spring arm of the spring member is configured to exert an outwardly directed spring biasing force on the contact arm of the first male terminal body, or
ii) when the male terminal assembly is in a fully coupled state S_{FC}, a gap is formed between an extent of an outer surface of the spring arm and an inner surface of the contact arm, or
iii) wherein in the connected state S_{CON}, an anti-rotation projection of the spring arm is positioned adjacent to an extent of the first male terminal body, or
iv) wherein in the connected state S_{CON}, the contact arm of the first male terminal assembly is wedged between the spring arm of the spring member and an inner surface of the first female terminal assembly.

27. The splice block system of claim 26, wherein the spring biasing force is oriented either substantially parallel, or substantially perpendicular, to the positioning force F_{P}.

28. (canceled)

29. The splice block system of claim 26, wherein the spring biasing force is oriented either substantially perpendicular, or substantially parallel, to the coupling force F_{C}.

30-113. (canceled)
